(19) United States
(12) Patent Application Publication
(10) Pub. No.: US 2023/0341516 A1
(43) Pub. Date: Oct. 26, 2023

(54) MIXED-MODE DISTRIBUTED COHERENT APERTURE TECHNIQUE FOR ERROR MITIGATION

(71) Applicant: Government of the United States, as represented by the Secretary of the Air Force, Wright-Patterson AFB, OH (US)

(72) Inventor: Andrew M. Kordik, Bellbrook, OH (US)

(73) Assignee: Government of the United States, as represented by the Secretary of the Air Force, Wright-Patterson AFB, OH (US)

(21) Appl. No.: 18/304,166

(22) Filed: Apr. 20, 2023

Related U.S. Application Data
(60) Provisional application No. 63/333,237, filed on Apr. 21, 2022.

(51) Int. Cl. G01S 7/40; G01S 13/00

(52) U.S. Cl. CPC G01S 7/40; G01S 13/003; G01S 7/4021

(57) ABSTRACT

In a system of receivers and transmitters, a mixed-mode distributed coherent aperture technique includes receiving a combination of separable transmit waveforms; processing the combination of separable transmit waveforms to estimate coherence parameters associated with each separable transmit waveform of the combination of separable transmit waveforms; based on an estimation of the coherence parameters, determining a signal model of a next set of transmissions of the separable transmit waveforms transmitted by a plurality of transmitters; processing the signal model according to a mixed-mode distributed coherent radar operating mode that is a function of coherence parameter errors associated with each separable transmit waveform and a size of the sub-array; and sending the processed signal model to the plurality of transmitters for each transmitter to generate its own separable transmit waveform selected from the separable waveforms for transmission.

### CROSS-REFERENCE TO RELATED APPLICATIONS

This application claims benefit to U.S. Provisional Patent Application Ser. No. 63/333,237, filed Apr. 21, 2022 and entitled “Mixed Mode Distributed Coherent Radar,” which is hereby incorporated by reference herein in its entirety.

### GOVERNMENT INTEREST

The invention described herein may be manufactured and used by or for the Government of the United States for all government purposes without the payment of any royalty.

### BACKGROUND

### Field of the Invention

The embodiments herein generally relate to radar and/or wireless communication systems, and more particularly to distributed coherent radar and/or wireless communication systems.

### Background of the Invention

Distributed Coherent Radar (DCR) concepts are a large scale analog to traditional electronically steered array concepts. Instead of closely spaced (i.e., typically D≤λ/2, where λ is the transmitted waveform's wavelength and D is the distance between elements) small radiating elements, DCR leverages multiple complete radars. Generally, these radars are widely separated (i.e., D>>>λ) and often on completely independent sensing platforms such as trucks, aircraft, and ships. Distributed Radio Frequency (RF) sensing has been studied and employed in the astronomical community since the mid-late 1940's as interferometric systems and continues today in systems such as the Very Long

Baseline Array.

When the modern concept of DCR was initially proposed, it extended the distributed sensing concept used in the astronomical community from passive receivers to the realm of active radars. Recent work in DCR codified the nomenclature of cohere-on-transmit (COT) and cohere-on-receive (COR). In the COR mode the distributed radar must align the returned signals across all bistatic paths during receive processing. A perfectly aligned COR system may achieve signal-to-noise ratios (SNRs) that scale as the square of the number of radars in the distributed array. Fixed-site multichannel COR arrays were examined and experimentally demonstrated 30 years ago, and the concept has since been extended as high as millimeter wave frequencies.

In contrast, the much more challenging COT mode must ensure the electromagnetic waves incident on a target are coherent. In doing so, a COT array may achieve SNRs that scale as the cube of the number of radars. Due to these significant and scalable improvements in SNR, COR and COT have been proposed as attractive solutions for a variety of radar applications—including weather radar, interference suppression, and improved target tracking. The COT coherency constraint at the target induces stringent requirements on the phase, frequency, and timing alignment across each element of the distributed array. The values required to achieve alignment are referred to as coherence parameters (CPs), and the deviance from ideal, as CP error. Conventionally, the majority of COT research has focused on techniques and analysis on minimizing CP error. An additional prominent area of study is to reduce CP requirements through use of robust waveforms. Further, some techniques encourage using both COR and COT in a system by placing a binary choice on COT and COR operation based on estimated performance. In other words, if it is decided that CP error is too great, such that coherence is lost, then the distributed array may “fall back” from a COT mode into the COR mode, in which CPs are estimated on receive rather than enforced on transmit, after refinement of the CPs the system may reenter COT mode and so on.

There does not appear to exist a comprehensive examination of CP error sensitivity to improve system performance. While the impact of individual errors has been considered in isolation in the literature, there has yet to be an exhaustive comparison of the impacts of the three primary CP errors as a function of array size. Also, while innovative, the binary switching between COT and COR does not allow for graceful degradation of performance in the face of changing coherence parameters and system errors.

### BRIEF SUMMARY OF THE INVENTION

In view of the foregoing, an embodiment herein provides a method comprising receiving, by a plurality of receivers, a combination of separable transmit waveforms from a plurality of transmitters, and optionally via a target or a plurality of targets (determined by employment as a radar or wireless communication system), wherein the plurality of transmitters are grouped into a sub-array; processing, by each receiver of the plurality of receivers, the combination of separable transmit waveforms to estimate coherence parameters associated with each separable transmit waveform of the combination of separable transmit waveforms; based on an estimation of the coherence parameters, determining, by each receiver of the plurality of receivers, a signal model of a next set of transmissions of the separable transmit waveforms transmitted by the plurality of transmitters; processing the signal model according to a mixed-mode distributed coherent radar operating mode that is a function of coherence parameter errors associated with each separable transmit waveform and a size of the sub-array, wherein the coherence parameter errors comprise delay, phase, amplitude, and frequency errors of the plurality of transmitters and the plurality of receivers, and wherein the signal model comprises a coherence parameter tolerance of a radar system comprising the plurality of transmitters and the plurality of receivers; and sending the processed signal model to the plurality of transmitters for each transmitter of the plurality of transmitters to generate its own separable transmit waveform selected from the separable waveforms for transmission.

The method further comprises transmitting a separable transmit waveform from each of the plurality of transmitters, wherein each transmitter of the plurality of transmitters transmits its own separable transmit waveform independent of separable transmit waveforms transmitted from other transmitters of the plurality of transmitters. The coherence parameter tolerance is dependent on the size of the sub-array. The processed signal model instructs the radar system to operate in the mixed-mode distributed coherent radar operating mode, a cohere-on-transmit (COT) operating mode, or a cohere-on-receive (COR) operating mode. The processed signal model provides operating instructions to the radar system on how to collectively improve system performance of the radar system given a current state of the coherence parameter errors. The operating instructions comprise selectively choosing different combinations of the separable transmit waveforms for transmission by each transmitter. Determining the signal model comprises performing an analysis of the number of radars in the radar system vs. a coherence parameter error tolerance of the radar system.

Another embodiment provides a machine-readable storage medium comprising computer-executable instructions that when executed cause a processor to identify a combination of separable transmit waveforms received by a plurality of receivers from a plurality of transmitters, and optionally via a target (or a plurality of targets), wherein the plurality of transmitters are grouped into a sub-array; instruct each receiver of the plurality of receivers to process the combination of separable transmit waveforms to estimate coherence parameters associated with each separable transmit waveform of the combination of separable transmit waveforms; instruct each receiver of the plurality of receivers, based on an estimation of the coherence parameters, how to determine a signal model of a next set of transmissions of the separable transmit waveforms transmitted by the plurality of transmitters; process the signal model according to a mixed-mode distributed coherent radar operating mode that is a function of coherence parameter errors associated with each separable transmit waveform and a size of the sub-array, wherein the coherence parameter errors comprise delay, phase, amplitude, and frequency errors of the plurality of transmitters and the plurality of receivers, and wherein the signal model comprises a coherence parameter tolerance of a radar system comprising the plurality of transmitters and the plurality of receivers; and send the processed signal model to the plurality of transmitters for each transmitter of the plurality of transmitters to generate its own separable transmit waveform selected from the separable waveforms for transmission.

The instructions, when executed, further cause the processor to instruct the plurality of transmitters to transmit a separable transmit waveform from each of the plurality of transmitters, wherein each transmitter of the plurality of transmitters is instructed to transmit its own separable transmit waveform independent of separable transmit waveforms transmitted from other transmitters of the plurality of transmitters. The coherence parameter tolerance is dependent on the size of the sub-array. The processed signal model instructs the radar system to operate in the mixed-mode distributed coherent radar operating mode, a COT operating mode, or a COR operating mode. The processed signal model provides operating instructions to the radar system on how to collectively improve system performance of the radar system given a current state of the coherence parameter errors. The operating instructions comprise selectively choosing different combinations of the separable transmit waveforms for transmission by each transmitter. Determining the signal model comprises performing an analysis of the number of radars in the radar system vs. a coherence parameter error tolerance of the radar system.

Another embodiment provides a system comprising a plurality of transmitters, wherein the plurality of transmitters are to transmit a separable transmit waveform from each of the plurality of transmitters directly towards the receivers for use as a wireless communication system, wherein each transmitter of the plurality of transmitters transmits its own separable transmit waveform independent of separable transmit waveforms transmitted from other transmitters of the plurality of transmitters, wherein the plurality of transmitters are grouped into a sub-array; a plurality of receivers, wherein each of the plurality of receivers are to receive a combination of separable transmit waveforms from the plurality of transmitters, wherein based on an estimation of the coherence parameters, each receiver is to determine a signal model of a next set of transmissions of the separable transmit waveforms transmitted by the plurality of transmitters; and a processor to process the signal model according to a mixed-mode distributed coherent communication sub-system operating mode that is a function of coherence parameter errors associated with each separable transmit waveform and a size of the sub-array, wherein the coherence parameter errors comprise delay, phase, amplitude, and frequency errors of the plurality of transmitters and the plurality of receivers, and wherein the signal model comprises a coherence parameter tolerance of a communication sub-system comprising the plurality of transmitters and the plurality of receivers; and send the processed signal model to the plurality of transmitters for each transmitter of the plurality of transmitters to generate its own separable transmit waveform selected from the separable waveforms for transmission.

The coherence parameter tolerance is dependent on the size of the sub-array. The processed signal model instructs the communication sub-system to operate in the mixed-mode distributed coherent transceiver system operating mode, a COT operating mode, or a COR operating mode. The processed signal model provides operating instructions to the communication sub-system on how to collectively improve system performance of the communication sub-system given a current state of the coherence parameter errors. The operating instructions comprise selectively choosing different combinations of the separable transmit waveforms for transmission by each transmitter. Each receiver is to determine the signal model by performing an analysis of the number of components in the communication sub-system vs. a coherence parameter error tolerance of the communication sub-system.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram illustrating a system that provides improved error tolerance via mixed-mode distributed coherent radar;

FIG. 2 is a block diagram illustrating various signal modes;

FIG. 3A is a flow diagram illustrating performing mixed-mode distributed coherent radar method for error mitigation;

FIG. 3B is a flow diagram illustrating performing transmission of separable transmit waveforms;

FIG. 4A is a block diagram illustrating a system to perform a mixed-mode distributed coherent radar technique for error mitigation;

FIG. 4B is a block diagram illustrating a system to perform transmission of separable transmit waveforms for a mixed-mode distributed coherent radar technique;

FIG. 5 is a system diagram illustrate a generalized bistatic cohere-on-receive architecture;

FIG. 6 is a system diagram illustrate a generalized bistatic cohere-on-transmit architecture;

FIG. 7 is a graph illustrating an example of performance of the phase error decoherence for varying number of radars in a DCR system N={2 . . . 8};

FIG. 8 is a graph illustrating an example of performance of the zoomed delay error decoherence for varying number of radars in a DCR system N={2 . . . 8};

FIG. 9 is a graph illustrating an example of performance of the frequency error decoherence for varying number of radars in a DCR system N={2 . . . 8};

FIG. 10 is a graph illustrating an example of an 8 radar mixed-mode DCR system with varying sub-array size, showing the graceful degradation between COT performance and COR performance achieved via a mixed-mode technique;

FIG. 11 is a graph illustrating an example of an 8 radar mixed-mode DCR system with varying sub-array size, showing the error tolerance offered by a mixed-mode technique in contrast with COT w/error performance and COR performance;

FIG. 12 is a graph illustrating an example of performance of the delay error analysis of mixed-mode DCR normalized to COR performance;

FIG. 13 is a graph illustrating an example of performance of the phase error analysis of mixed-mode DCR normalized to COR performance;

FIG. 14 is a graph illustrating an example of performance of the frequency error analysis of mixed-mode DCR normalized to COR performance;

FIG. 15 is a graph illustrating an example of performance of the delay error analysis of mixed-mode DCR normalized to COT performance, highlighting the region with improvement over COR baseline;

FIG. 16 is a graph illustrating an example of performance of the phase error analysis of mixed-mode DCR normalized to COT performance, highlighting region with improvement over COR baseline; and

FIG. 17 is a graph illustrating an example of performance of the frequency error analysis of mixed-mode DCR normalized to COT performance, highlighting region with improvement over COR Baseline.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF THE INVENTION

Embodiments of the disclosed invention, its various features and the advantageous details thereof, are explained more fully with reference to the non-limiting embodiments that are illustrated in the accompanying drawings and detailed in the following description. Descriptions of well-known components and processing techniques are omitted to not unnecessarily obscure what is being disclosed. Examples may be provided and when so provided are intended merely to facilitate an understanding of the ways in which the invention may be practiced and to further enable those of skill in the art to practice its various embodiments. Accordingly, examples should not be construed as limiting the scope of what is disclosed and otherwise claimed.

It will be understood that when an element or layer is referred to as being “on”, “connected to”, or “coupled to” another element or layer, it may be directly on, directly connected to, or directly coupled to the other element or layer, or intervening elements or layers may be present. In contrast, when an element or layer is referred to as being “directly on”, “directly connected to”, or “directly coupled to” another element or layer, there are no intervening elements or layers present. It will be understood that for the purposes of this disclosure, “at least one of X, Y, and Z” or “any of X, Y, and Z” may be construed as X only, Y only, Z only, or any combination of two or more items X, Y, and Z (e.g., XYZ, XY, XZ, YZ).

The description herein describes inventive examples to enable those skilled in the art to practice the embodiments herein and illustrate the best mode of practicing the embodiments herein. Upon reading the following description in light of the accompanying drawing figures, those skilled in the art will understand the concepts of the disclosure and will recognize applications of these concepts not particularly addressed herein.

The terms first, second, etc. may be used herein to describe various elements, but these elements should not be limited by these terms as such terms are only used to distinguish one element from another. For example, a first element could be termed a second element, and, similarly, a second element could be termed a first element, etc. without departing from the scope of the present disclosure. As used herein, the term “and/or” includes any and all combinations of one or more of the associated listed items.

Moreover, when an element is referred to as being “connected”, “operatively connected”, or “coupled” to another element, it can be directly connected or coupled to the other element or intervening elements may be present. Conversely, when an element is referred to as being “directly connected” or “directly coupled” to another element, there are no intervening elements present.

Furthermore, although the terms “upper”, “lower”, “bottom”, “side”, “intermediate”, “middle”, and “top”, etc. may be used herein to describe various elements, but these elements should not be limited by these terms. These terms are only used to distinguish one element from another. For example, a first element could be termed an “top” element and, similarly, a second element could be termed a “top” element depending on the relative orientations of these elements.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprise(s)”, “comprising”, “include(s)”, and/or “including” when used herein specify the presence of stated features, integers, steps, operations, elements, and/or components, but do not preclude the presence or addition of one or more other features, integers, steps, operations, elements, components, and/or groups thereof.

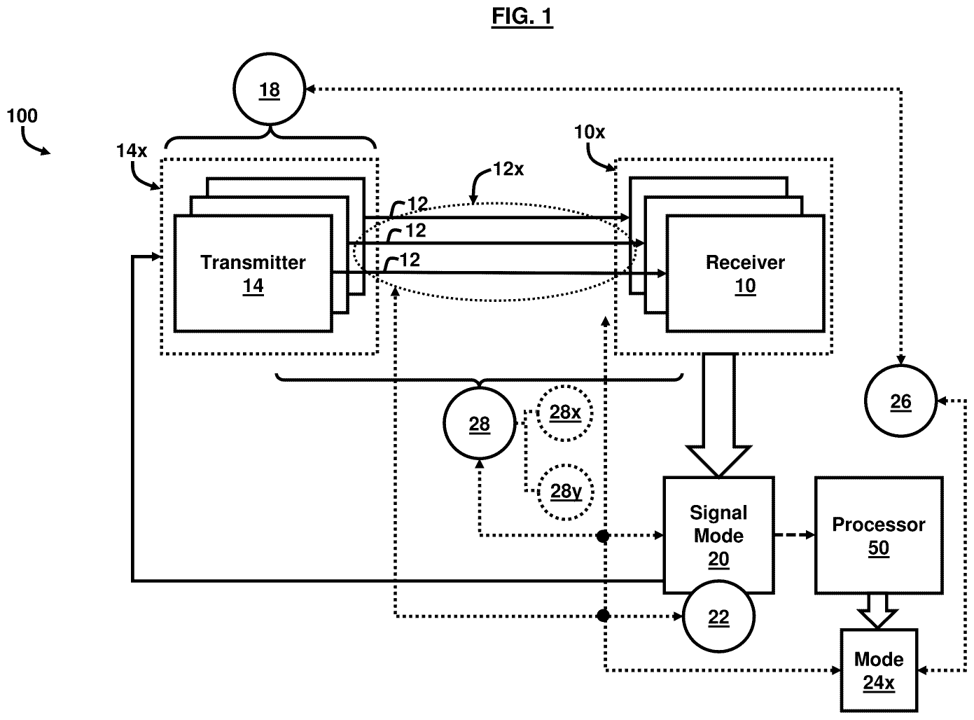

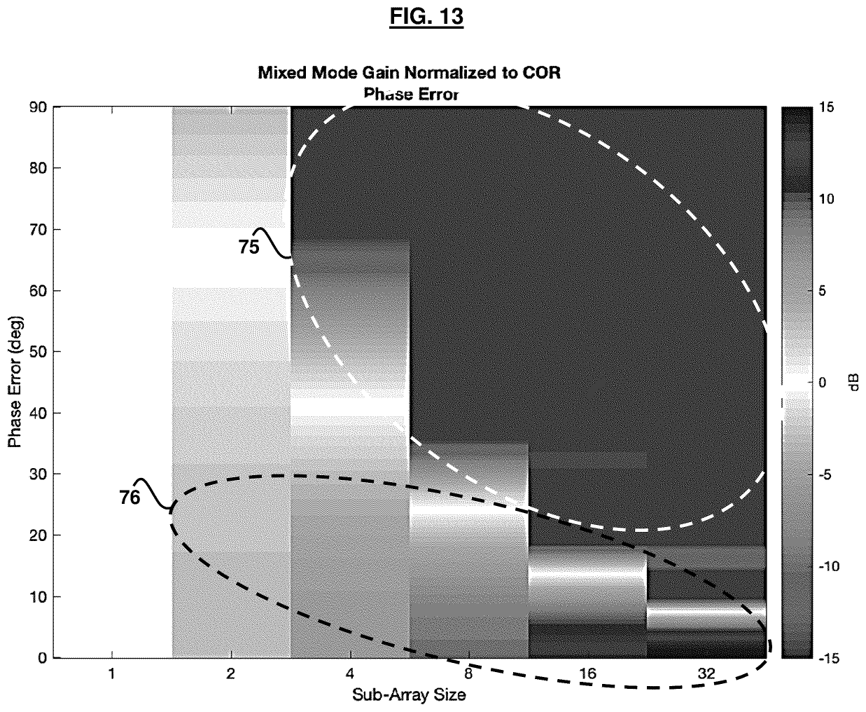

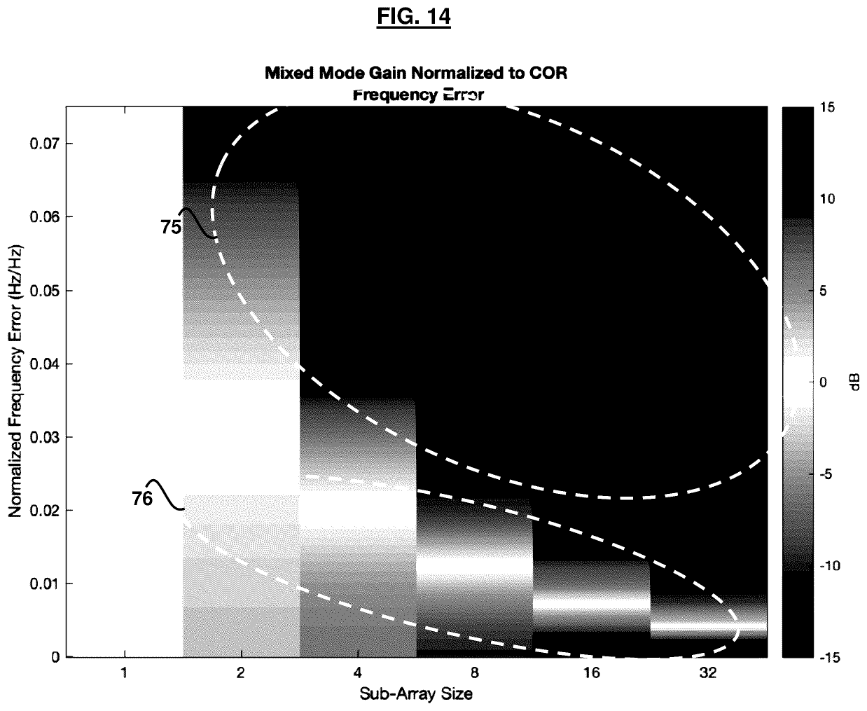

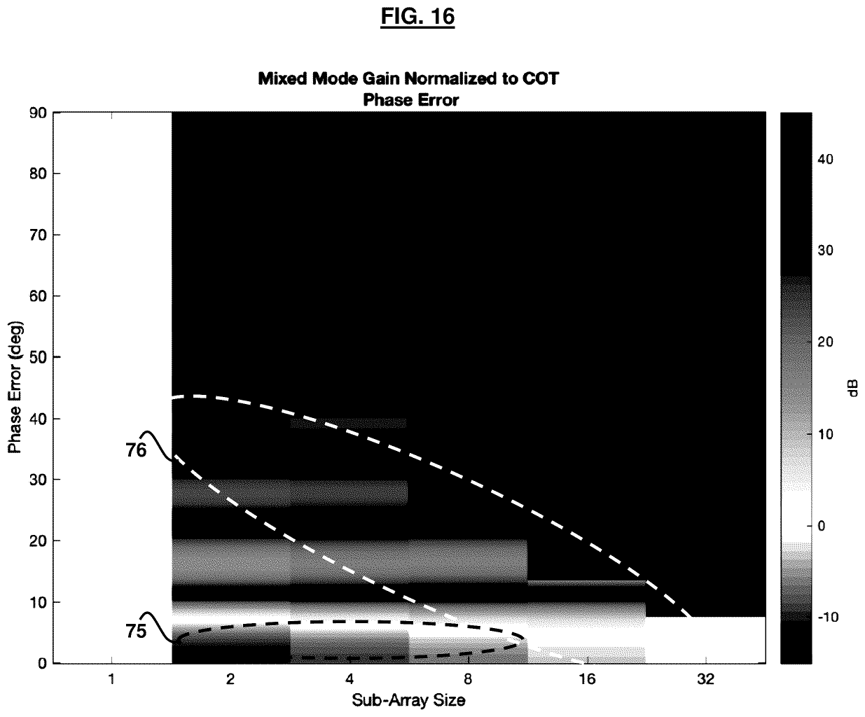

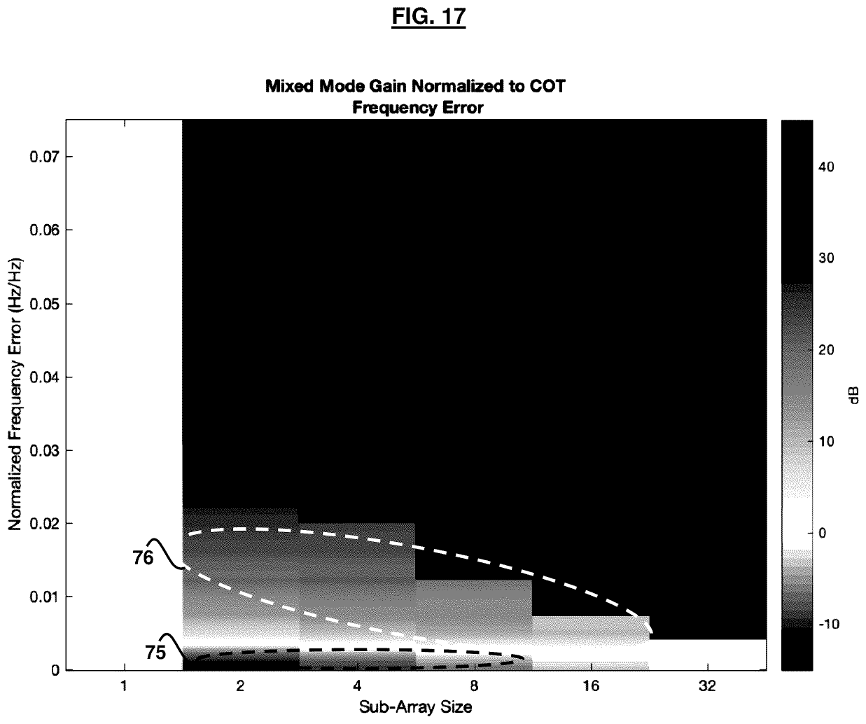

Distributed coherent radar is a challenging modality with the potential to maximize the signal-to-noise ratio—scaling in the limit to the cube of the number of coherent radars. However, this radar mode degrades non-linearly as a function of mismatch in phase, frequency, and timing across the distributed aperture. Distributed coherent radar techniques can be generalized to distributed coherent aperture techniques such that they can be applied to a variety of radio frequency (RF) system applications including both radar and wireless communication systems. Accordingly, the embodiments herein provide a technique to address the sensitivity of the cohere-on-transmit (COT) mode to these inevitable errors, and an innovative mode termed “mixed-mode DCR” is provided. This new mode provides a graceful degradation of performance as mismatch errors accumulate, rather than the traditional binary choice between COT and COR. Moreover, the embodiments herein provide a comprehensive, waveform agnostic, first-principles coherence parameter error technique to parameterize the impact of delay, phase, amplitude, and frequency errors as a nonlinear function of the number of radars in the network. Furthermore, the embodiments herein provide a unique “mixed-mode” DCR (MM-DCR) operating mode technique in which the total array is broken into smaller COT sub-arrays whose size is dependent on the total coherence parameter error. It is shown that the MM-DCR mode allows for graceful performance degradation from COT to COR mode, which can be tuned to the current level of errors present in the system. As a further improvement, the coherence parameter tolerance becomes dependent on the size of the sub-array—not the total system size. Consequently, COT becomes both easier to achieve and more robust. Referring now to the drawings, and more particularly to FIGS. 1 through 17, where similar reference characters denote corresponding features consistently throughout, there are shown exemplary embodiments. In the drawings, the size and relative sizes of components, layers, and regions, etc. may be exaggerated for clarity.

FIG. 1 illustrates a system 100 comprising a plurality of transmitters 14x. In an example the plurality of transmitters 14x may comprise transceivers. In some examples, the plurality of transmitters 14x may be stationary or mobile. The plurality of transmitters 14x are to transmit a separable transmit waveform 12 from each of the plurality of transmitters 14x, and optionally towards with a target 16 (or a plurality of targets (in a radar embodiment)). Each transmitter 14 of the plurality of transmitters 14x transmits its own separable transmit waveform 12 independent of separable transmit waveforms 12x transmitted from other transmitters 14 of the plurality of transmitters 14x. According to the embodiments herein, the plurality of transmitters 14x are grouped into a sub-array 18.

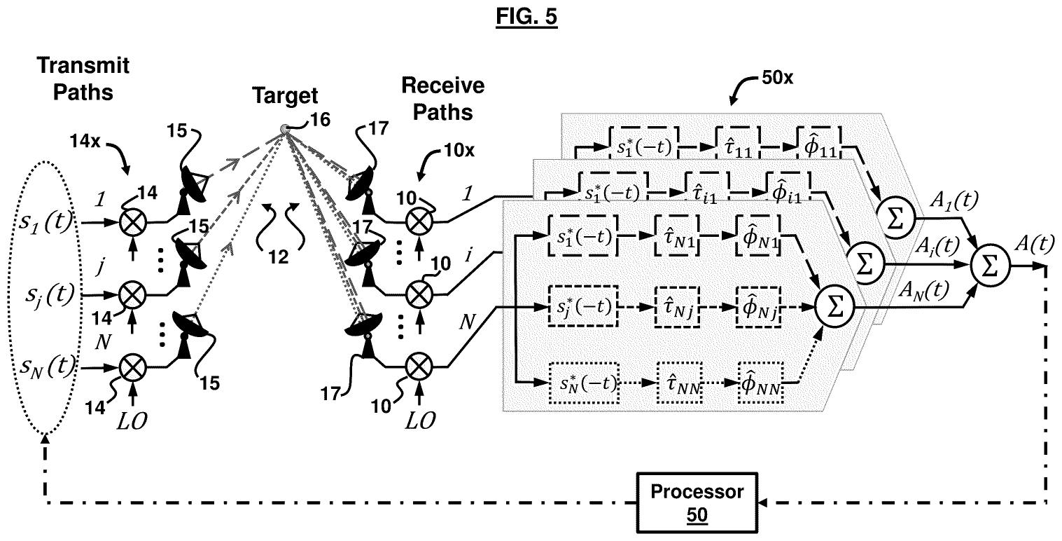

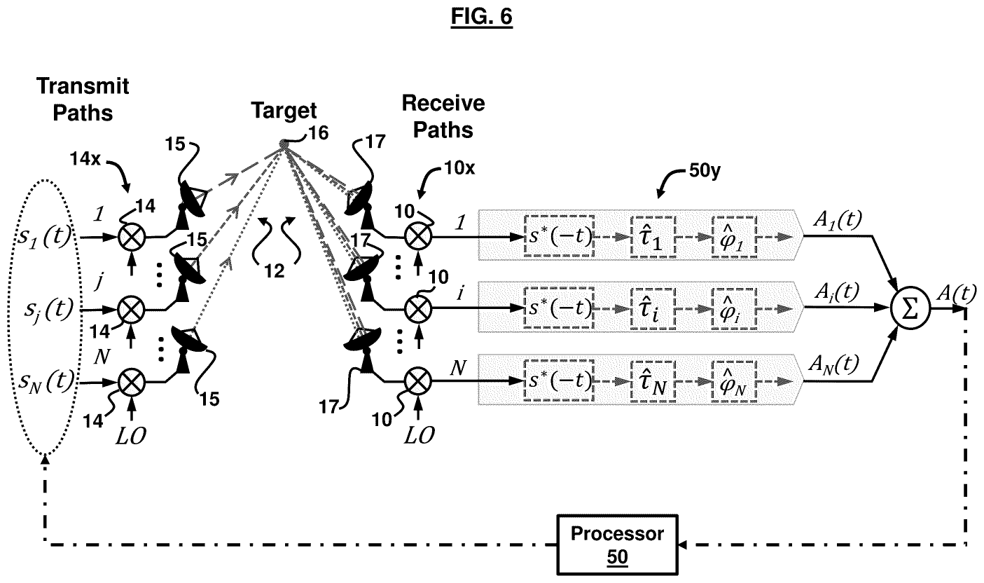

Each transmitter 14 of the plurality of transmitters 14x is configured to transmit arbitrary waveforms such as the separable transmit waveform 12. In an example, each transmitter 14 may comprise a type of radiating apparatus such as a dish or horn antenna or an electronically steerable array antenna such as antenna 15 (shown in FIGS. 5 and 6). The radiating element may be steerable (electrically or mechanically), or it may be fixed. When fixed generally a wide or omni directional beam pattern may be utilized. Furthermore, each transmitter 14 may utilize some type of amplification to amplify the separable transmit waveform 12. In other embodiments, each transmitter 14 may be configured to adjust waveform transmission by applying coherence parameter (e.g., amplitude, delay, phase, and frequency). In cases when systems cannot apply coherence parameters the system 100 may only be usable as stand-alone COR elements. Various types of transmitters 14x may be utilized. For the waveform generation portion of the transmitter 14, some examples include a software defined radio, a modified modern radar system, a COTS arbitrary waveform generator, or a custom computer+digital-to-analog converter (DAC). For the amplifier portion of the transmitter 14, some examples include pulsed or continuous wave (CW) amplified or any class (though some classes may yield better performance). For the antenna portion of the transmitter 14, some examples include gimbaled dish, gimbaled horn, fixed monopole, gimbaled or fixed active electronically scanned array (AESA), or gimbaled or fixed passive electronically scanned array (PESA). Furthermore, each transmitter 14 may be installed to be fixed such as part of a ground based installation or configured to be mobile (both during or in between operation) for installation on, for example, vehicles such as cars and trucks, boats, airplanes, UAVs, or satellites. In either case, the plurality of transmitters 14x are generally widely separated by significantly more than the operational carrier wavelength of the systems. This may imply meters, 10's of meters, or even 1,000's or 10,000's of kilometers (such as the event horizon telescope). In this regard, the spacing between each transmitter 14 may have system performance implications. According to some examples, system 100 is monostatic (combined transmitter/receiver “transceiver”) or bistatic (separate transmitter and receiver). Moreover, the monostatic and bistatic configurations can be combined; i.e., some elements may be monostatic others may be bistatic. Initially, the plurality of transmitters 14x may be independent searching, or externally queued. Moreover, the plurality of transmitters 14x may all transmit separable waveforms initially or may be able to start with some coherent or coordinated operation potentially driven by the processor 50. For general COT/COR and mixed-mode operation the plurality of transmitters 14x may be coordinated and/or controlled by the processor 50.

The system 100 further comprises a plurality of receivers 10x. In an example the plurality of receivers 10x may comprise transceivers. In some examples, the plurality of receivers 10x may be stationary or mobile. Each of the plurality of receivers 10x are to receive a combination of separable transmit waveforms 12x from the plurality of transmitters 14x, and optionally after interacting with a target 16 (or a plurality of targets). Moreover, based on an estimation of the coherence parameters (CPs), each receiver 10 is to determine a signal model 20 of a next set of transmissions 22 of the separable transmit waveforms 12x transmitted by the plurality of transmitters 14x.

Each receiver 10 of the plurality of receivers 10x generally observes returns from the plurality of transmitters 14x, and optionally after interacting with a target 16 (or a plurality of targets). In general, the operation of all the transmitters 14x may be observed, however it is possible only some or none of the signals (i.e., separable transmit waveform 12) reach the receivers 10x. Similar to the transmitters 14x the receivers 10x comprise some type of antenna element such as a dish, horn, monopole, AESA, or PESA, etc. Moreover, the receivers 10x may be fixed or steered and may be separated in space. Each receiver 10 includes receiving and digitization hardware and may optionally include processing hardware. When processing hardware is not present, all processing described here may be completed by the processor 50 and thus received signals may be sent to the processor 50 accordingly.

The system 100 further comprises a processor 50 to process the signal model according to a mixed-mode distributed coherent communication sub-system operating mode 24x that is a function of coherence parameter errors 26 associated with each separable transmit waveform 12 and a size of the sub-array 18. The coherence parameter errors 26 comprise delay, phase, amplitude, and frequency errors of the plurality of transmitters 14x and the plurality of receivers 10x. Moreover, the signal model 20 comprises a coherence parameter tolerance of a communication sub-system 28 comprising the plurality of transmitters 14x and the plurality of receivers 10x. The processor 50 is to send the processed signal model 20 to the plurality of transmitters 14x for each transmitter 14 of the plurality of transmitters 14x to generate its own separable transmit waveform 12 selected from the separable waveforms 12x for transmission to the plurality of receivers 10x. In some examples, the communication sub-system 28 may be a radar system 28x or a communication system 28y. However, the embodiments herein are not restricted to these particular examples.

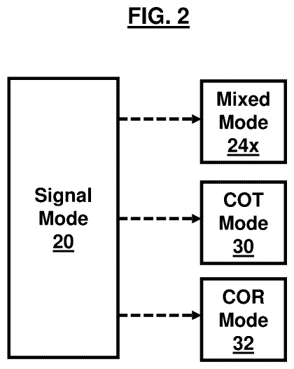

In an example, the coherence parameter tolerance is dependent on the size of the sub-array 18. Furthermore, the processed signal model 20 instructs the communication sub-system 28 to operate in the mixed-mode distributed coherent transceiver system operating mode 24x, a COT operating mode 30, or a COR operating mode 32, as indicated in FIG. 2. The processed signal model 20 provides operating instructions to the communication sub-system 28 on how to collectively improve system performance of the communication sub-system 28 given a current state of the coherence parameter errors 26. Additionally, the operating instructions comprise selectively choosing different combinations of the separable transmit waveforms 12x for transmission by each transmitter 14. Each receiver 10 is to determine the signal model 20 by performing an analysis of the number of components in the communication sub-system 28 vs. a coherence parameter error tolerance of the communication sub-system 28. In some examples, the components may be radars or a radar system 28x. However, the embodiments herein are not restricted to these particular examples.

The receivers 10x processes returns by separating returns, estimating coherence parameters (or receiving them from some external system such as the processor 50), applying coherence parameters, and combining returns. The receivers 10x may optionally perform further radar processing in pursuit of higher level operations such as synthetic-aperture radar (SAR) or moving target indication (MTI). Furthermore, the receivers 10x may optionally perform further communication processing such as symbol demodulation (either completely or partially). The intermediate results (regardless of form) are then sent to the processor 50.

With respect to the separable waveforms, the plurality of transmitters 14x must transmit at nearly the same time (roughly on the order of a pulse repetition interval (PRI)). To achieve this, orthogonal (or more accurately “separable”) transmit waveforms 12 are used such that cross interference is minimized between radar elements. The orthogonal/separable transmit waveforms 12 may be achieved by using a variety of multiplexing techniques including, but not limited to: frequency division, time division, Doppler division, or code division. Each technique may have various performance implications on the entire system 100. With respect to FIGS. 5 and 6, each type of dashed/dotted line with respect to the waveforms 12 in the diagram is separable from the other waveforms. Moreover, these respective dashed/dotted lines follow through and are consistent with the dashed/dotted lines shown in the back-end 50x, 50y processes. While only one example set is shown for illustration in FIGS. 5 and 6, all permutations are possible in accordance with the embodiments herein.

In the communications case, electromagnetic energy is transmitted in the direction of the desired plurality of receivers 10x. In the radar case, the electromatic energy is generally directed towards, and reflected off the target 16 (or a plurality of targets). However, in some radar applications a target 16 may not be present (i.e., the detection of targets being the principal goal of some radar modes such as area search, etc.). The signals (i.e., separable transmit waveform 12) reradiated by the target 16 are generally “super imposed” (i.e., the signals are added together and then filtered). The target 16 may be stationary or mobile. The communication case assumes this stage directly after transmission of the separable transmit waveform 12 by each transmitter 14.

The processor 50, which may be a centralized processor, provides computing capability. In some examples, the processor 50 may be a single system or it may be based on any combination of compute elements such as CPUs, FPGAs, GPGPUS, etc. Additionally, the processor 50 may be federated. In this regard, each receiver 10 may have “part” of the processor 50; each performing a partition of the processing and decision marking and passing data to some “master” element of the processor 50. The processor 50 is operatively and communicatively connected to the plurality of transmitters 14x and the plurality of receivers 10x for both data and control.

In the communication case, the processor 50 may be replicated on each side of the link. Moreover, the processor 50 may not necessarily be directly connected to both the transmitters 14x and receivers 10x. Instead, the control information may be passed back to/from the processor 50 over the wireless link. The processor 50 combines data from all receivers 10x and performs the final radar/com activity (e.g., form SAR images, Decode Message, etc.). Additionally, the processor 50 may estimate coherence parameters for transmission and optionally perform receive functions. Furthermore, the processor 50 may select which elements operate in mixed-mode together.

The selection of sub-arrays 18 for mixed mode operations as well as coherence parameter selection may be optimized based on a variety of conditions including, but not limited to: For SNR, to maximize SNR given system performance under the current operational constraints. For example, given the amount of error in the application of coherence parameters the sub-arrays 18 may be selected to maximize SNR. For beam performance, the sub-arrays 18 may be selected to achieve certain beam performance metrics. For example, multiple beams may be used to improve overall system geolocation, or to null out interference, or minimize side lobes, etc. For calibration, sub-array selection may be optimized by permuting on some interval to achieve calibration of individual or groups of transmitters 14x. For spectral congestion, sub-array selection may be based on current spectral congestion. COR modes may not be feasible in the current spectral environment. For example, systems achieving waveform separability by employing frequency division techniques may not have enough spectrum available for all elements to use different portions of the spectrum. For sensor resource management, akin to traditional monostatic radars the processor 50 may optimize sub-arrays 18 and coherence parameters to meet traditional sensor resource management challenges; e.g., interleaved sensing modes (e.g., search-while-track). The resulting processed data is then used for either radar or communication purposes. Furthermore, the resulting coherence parameters and sub-array settings are sent to the plurality of transmitters 14x and the process is repeated.

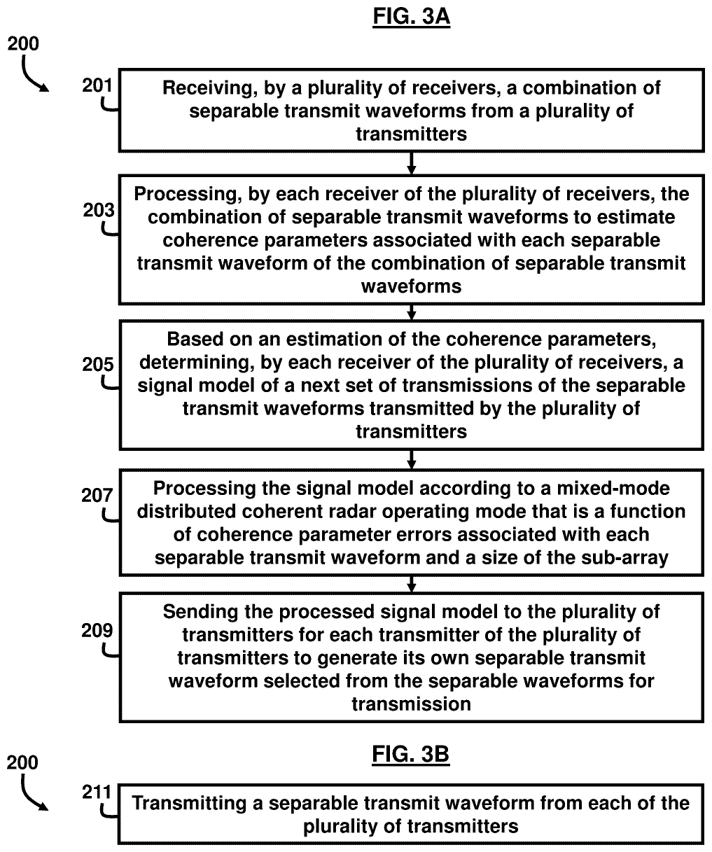

FIGS. 3A and 3B are flow diagrams illustrating a method 200 comprising receiving (201), by a plurality of receivers 10x, a combination of separable transmit waveforms 12x from a plurality of transmitters 14x, and optionally via a target 16 (or a plurality of targets), wherein the plurality of transmitters 14x are grouped into a sub-array 18; processing (203), by each receiver 10 of the plurality of receivers 10x, the combination of separable transmit waveforms 12x to estimate coherence parameters CPs associated with each separable transmit waveform 12 of the combination of separable transmit waveforms 12x; based on an estimation of the coherence parameters CPs, determining (205), by each receiver 10 of the plurality of receivers 10x, a signal model 20 of a next set of transmissions 22 of the separable transmit waveforms 12x transmitted by the plurality of transmitters 14x; processing (207) the signal model 20 according to a mixed-mode distributed coherent radar operating mode 24 that is a function of coherence parameter errors 26 associated with each separable transmit waveform 12 and a size of the sub-array 18, wherein the coherence parameter errors 26 comprise delay, phase, amplitude, and frequency errors of the plurality of transmitters 14x and the plurality of receivers 10x, and wherein the signal model 20 comprises a coherence parameter tolerance of a radar system 28x comprising the plurality of transmitters 14x and the plurality of receivers 10x; and sending (209) the processed signal model 20 to the plurality of transmitters 14x for each transmitter 14 of the plurality of transmitters 14x to generate its own separable transmit waveform 12 selected from the separable waveforms 12x for transmission to the target 16.

The method 200 further comprises transmitting (211) a separable transmit waveform 12 from each of the plurality of transmitters 14x to the target 16, wherein each transmitter 14 of the plurality of transmitters 14x transmits its own separable transmit waveform 12 independent of separable transmit waveforms 12x transmitted from other transmitters 14 of the plurality of transmitters 14x. The coherence parameter tolerance is dependent on the size of the sub-array 18. The processed signal model 20 instructs the radar system 28x to operate in the mixed-mode distributed coherent radar operating mode 24, a cohere-on-transmit (COT) operating mode 30, or a cohere-on-receive (COR) operating mode 32. The processed signal model 20 provides operating instructions to the radar system 28x on how to collectively improve system performance of the radar system 28x given a current state of the coherence parameter errors 26. The operating instructions comprise selectively choosing different combinations of the separable transmit waveforms 12x for transmission by each transmitter 14. Determining the signal model 20 comprises performing an analysis of the number of radars in the radar system 28x vs. a coherence parameter error tolerance of the radar system 28x. According to the mixed-mode technique provided by the embodiments herein, some controller systems provide input on what is transmitted and that transmitters 14x may be grouped into a sub-array 18.

In an exemplary embodiment, the processes performed by the method 200 may be programmed on the processor 50, which may contain various modules. These modules may be embodied as hardware-enabled modules and may be configured as a plurality of overlapping or independent electronic circuits, devices, and discrete elements packaged onto a circuit board to provide data and signal processing functionality within a computer. An example might be a comparator, inverter, or flip-flop, which could include a plurality of transistors and other supporting devices and circuit elements. The modules that are configured with electronic circuits process computer logic instructions capable of providing at least one digital signal or analog signal for performing various functions as described herein. The various functions can further be embodied and physically saved as any of data structures, data paths, data objects, data object models, object files, database components. For example, the data objects could be configured as a digital packet of structured data. The data structures could be configured as any of an array, tuple, map, union, variant, set, graph, tree, node, and an object, which may be stored and retrieved by computer memory and may be managed by processors, compilers, and other computer hardware components. The data paths can be configured as part of a computer CPU that performs operations and calculations as instructed by the computer logic instructions. The data paths could include digital electronic circuits, multipliers, registers, and buses capable of performing data processing operations and arithmetic operations (e.g., Add, Subtract, etc.), bitwise logical operations (AND, OR, XOR, etc.), bit shift operations (e.g., arithmetic, logical, rotate, etc.), complex operations (e.g., using single clock calculations, sequential calculations, iterative calculations, etc.). The data objects may be configured as physical locations in computer memory and can be a variable, a data structure, or a function. In the embodiments configured as relational databases (e.g., such as Oracle® relational databases), the data objects can be configured as a table or column. Other configurations include specialized objects, distributed objects, object-oriented programming objects, and semantic web objects, for example. The data object models can be configured as an application programming interface for creating HyperText Markup Language (HTML) and Extensible Markup Language (XML) electronic documents. The models can be further configured as any of a tree, graph, container, list, map, queue, set, stack, and variations thereof. The data object files are created by compilers and assemblers and contain generated binary code and data for a source file. The database components can include any of tables, indexes, views, stored procedures, and triggers.

In an example, the embodiments herein can provide a computer program product configured to include a pre-configured set of instructions, which when performed, can result in actions as stated in conjunction with various figures herein. In an example, the pre-configured set of instructions can be stored on a tangible non-transitory computer readable medium. In an example, the tangible non-transitory computer readable medium can be configured to include the set of instructions, which when performed by a device, can cause the device to perform acts similar to the ones described here.

The embodiments herein may also include tangible and/or non-transitory computer-readable storage media for carrying or having computer-executable instructions or data structures stored thereon. Such non-transitory computer readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a special purpose computer or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Moreover, the various examples described herein may include both hardware and software elements. The examples that are implemented in software may include firmware, resident software, microcode, etc. Other examples may include a computer program product configured to include a pre-configured set of instructions, which when performed, may result in actions as stated in conjunction with the methods described above. In an example, the preconfigured set of instructions may be stored on a tangible non-transitory computer readable medium or a program storage device containing software code.

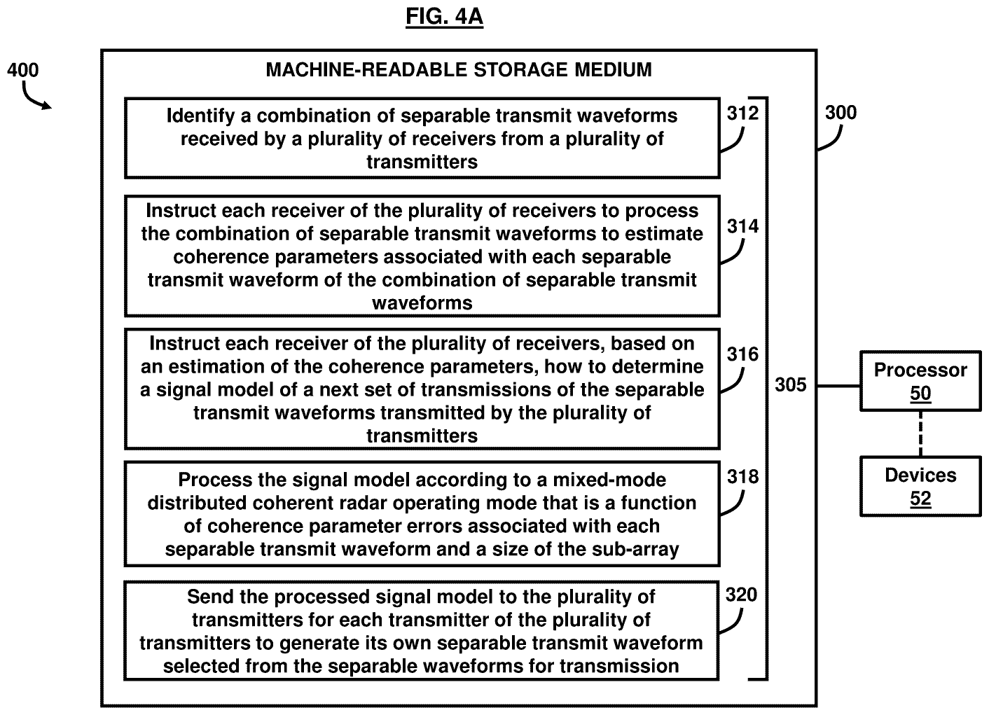

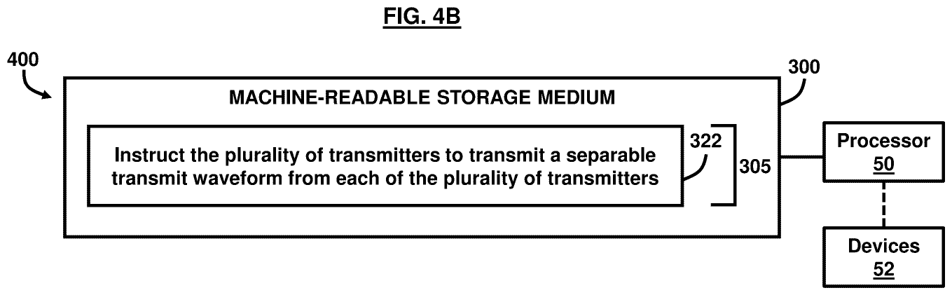

FIGS. 4A and 4B illustrate an example system 400 for performing a mixed-mode distributed coherent radar technique. In the example of FIGS. 4A and 4B, the system 400 includes a machine-readable storage medium 300 comprising computer-executable instructions 305 that when executed cause a processor 50 to provide various instructions 312-322 for execution by the system 400.

Processor 50 may include a central processing unit, microprocessors, hardware engines, and/or other hardware devices suitable for retrieval and execution of instructions stored in a machine-readable storage medium 300. Processor 50 may fetch, decode, and execute computer-executable instructions 305 to enable execution of locally-hosted or remotely-hosted applications for controlling action of the system 400. The remotely-hosted applications may be accessible on one or more remotely-located devices 52. For example, the remotely-located devices 52 may be a laptop computer, tablet device, smartphone, or notebook computer, etc. As an alternative or in addition to retrieving and executing instructions, processor 50 may include electronic circuits including a number of electronic components for performing the functionality of the computer-executable instructions 305.

The machine-readable storage medium 300 may be any electronic, magnetic, optical, or other physical storage device that stores executable instructions. Thus, the machine-readable storage medium 300 may be, for example, Random Access Memory, an Electrically-Erasable Programmable Read-Only Memory, volatile memory, non-volatile memory, flash memory, a storage drive (e.g., a hard drive), a solid-state drive, optical drive, any type of storage disc (e.g., a compact disc, a DVD, etc.), and the like, or a combination thereof. In one example, the machine-readable storage medium 300 may include a non-transitory computer-readable storage medium 300. The machine-readable storage medium 300 may be encoded with executable instructions for enabling execution of remotely-hosted applications accessed on the remotely-located devices 52.

Identifying instructions 312 may identify a combination of separable transmit waveforms 12x received by a plurality of receivers 10x from a plurality of transmitters 14x and optionally via a target 16, wherein the plurality of transmitters 14x are grouped into a sub-array 18. Instructing instructions 314 may instruct each receiver 10 of the plurality of receivers 10x to process the combination of separable transmit waveforms 12x to estimate coherence parameters CPs associated with each separable transmit waveform 12 of the combination of separable transmit waveforms 12x. Instructing instructions 316 may instruct each receiver 10 of the plurality of receivers 10x, based on an estimation of the coherence parameters CPs, how to determine a signal model 20 of a next set of transmissions 22 of the separable transmit waveforms 12x transmitted by the plurality of transmitters 14x. Processing instructions 318 may process the signal model 20 according to a mixed-mode distributed coherent radar operating mode 24 that is a function of coherence parameter errors 26 associated with each separable transmit waveform 12 and a size of the sub-array 18, wherein the coherence parameter errors 26 comprise delay, phase, amplitude, and frequency errors of the plurality of transmitters 14x and the plurality of receivers 10x, and wherein the signal model 20 comprises a coherence parameter tolerance of a radar system 28x comprising the plurality of transmitters 14x and the plurality of receivers 10x. Sending instructions 320 may send the processed signal model 20 to the plurality of transmitters 14x for each transmitter 14 of the plurality of transmitters 14x to generate its own separable transmit waveform 12 selected from the separable waveforms 12x for transmission to the plurality of receivers 10x.

Instructing instructions 322 may instruct the plurality of transmitters 14x to transmit a separable transmit waveform 12 from each of the plurality of transmitters 14x, wherein each transmitter 14 of the plurality of transmitters 14x is instructed to transmit its own separable transmit waveform 12 independent of separable transmit waveforms 12x transmitted from other transmitters 14 of the plurality of transmitters 14x. The coherence parameter tolerance is dependent on the size of the sub-array 18. The processed signal model 20 instructs the radar system 28x to operate in the mixed-mode distributed coherent radar operating mode 24, a COT operating mode 30, or a COR operating mode 32. The processed signal model 20 provides operating instructions to the radar system 28x on how to collectively improve system performance of the radar system 28x given a current state of the coherence parameter errors 26. The operating instructions comprise selectively choosing different combinations of the separable transmit waveforms 12x for transmission by each transmitter 14. Determining the signal model 20 comprises performing an analysis of the number of radars in the radar system 28x vs. a coherence parameter error tolerance of the radar system 28x.

The various processes performed by the method 200 and the computer-executable instructions 305 may be performed in accordance with the following descriptions.

Cohere-On-Receive

COR Mode DCR systems may be composed of radars in monostatic or bistatic configurations. FIG. 5 illustrates an example of a generalized COR architecture composed of bistatic radars, which may be utilized in accordance with the embodiments herein. In this configuration the transmit and receive hardware are spatially separated by a fairly large distance. Specifically, the bistatic angle with respect to the target is several degrees and the one-way propagation distance is much larger than the physical dimensions of the radar.

In a fully monostatic COR configuration, the same antennas, local oscillators (LO), and master clock (not shown) may be used for all transmit and receive paths which are fully colocated (i.e., no longer separate radars). In this case, the COR architecture converges to that of traditional multiple-input multiple-output (MIMO) radar and is no longer in the distributed paradigm.

Transmit Model: For illustration, three of the N transmit paths are shown on the left side of FIG. 1. An aspect of COR is the ability to distinguish the target reflections from each transmitter 14 at each receiver 10. Therefore, each transmit path has its own specific waveform, sⱼ(t), an RF transmitter 14, and a transmit antenna 15. In each transmit path, the transmitter 14 mixes its baseband radar waveform with a local oscillator (LO), up-converting it to an RF carrier frequency appropriate for radiation by the antenna 15.

The desired set of N transmit waveforms, sₙ(t), n=1, N is composed of separable waveforms. Ideally, these waveforms would be truly orthogonal. However, due to Parseval's Theorem, orthogonality is impractical in realizable systems. Therefore, in practice the waveforms used in a DCR system must be designed such that their cross-ambiguity function is minimized, and their auto-ambiguity function also approaches the desired “thumb-tack” response. An alternate definition for orthogonal waveforms is simply to have a “low cross-correlation”. Equation (1) shows the desired cross-ambiguity function modified from the traditional single waveform auto-ambiguity function, where χ_{i,j}(τ, f_{d}) is the cross-ambiguity response for the i^{th} receive waveform with a propagation delay of τ seconds and a Doppler frequency shift of f_{d} Hz against the j^{th} transmitted waveform.

$$\begin{matrix}{χ}_{i , j} ( τ , {f}_{d} ) = {\int }_{- ∞}^{∞} {s}_{j} ( t ) {s}_{i}^{*} ( t - τ ) {e}^{j 2 π {f}_{d} t} d t \\ = 0 , ∀ i \neq j \\ = δ ( τ ) δ ( f ) , i = j\end{matrix} \qquad ( 1 )$$

The use of low-cross-ambiguity waveforms is critical to approach the theoretical bounds of DCR performance, as residual cross-waveform responses will degrade the system performance. Further, such effects are multiplicative, meaning that they cannot be overcome with additional power or improved system coherence.

Free-Space Propagation: For simplicity and without loss of generality, it is initially assumed the transmitters 14 are synchronized, allowing the waveforms to propagate through free-space toward the target 16 as an ensemble of electromagnetic plane waves. In practice COR systems may transmit at nearly the same time, for example within the same Pulse Repetition Interval (PRI) or even within the same pulse duration depending on the alignment source and system stability. Calibration techniques may then be employed to time-align the received signals. The transmitted waves undergo free space propagation and are scattered by the target 16, which re-radiates a portion of their energy in the direction of each of the N receive antennas 17. Consequently, a superposition of N plane waves impinges on all N receive antennas 17, with different relative timing and amplitude due to the different propagation paths through freespace.

Receive Model: In each receive path, the N received signals are down-converted by the receivers 16, and digitized for radar post-processing. As before, only three of the N receive paths in the COR architecture are shown for clarity, and from the top, they are the 1^{st}, i^{th}, and N^{th}. A receive path is defined to be comprised of a receive antenna 17, an RF receiver 10, and a digital back-end 50x. Each digital back-end 50x contains N rows of parallel digital signal processing channels. The digital components in each channel are matched to their corresponding transmit waveforms, sⱼ. Within each digital back-end 50x, there are also a set of N matched filters, with impulse response hⱼ such that {hₙ(t)=s*ₙ(−t), ∀n=1, . . . , N}, aligned in a vertical column called a matched filter bank. These filters detect and isolate the N transmitted waveforms, to the extent they meet the conditions in Equation (1), for separate processing. For example, the matched filter, s*_{N}(−t), in the bottom row selects only the N^{th} transmitted waveform and rejects all N−1 other waveforms from the set. Similarly, the components in the middle row isolate and process only the corresponding j^{th} waveform. The components in the first row of the digital back-end process only the 1^{st} waveform. Multiplexing the signal to each filter in the matched filter bank does the same for the system noise, and thus N correlated copies of the receivers' noise are added to the signal chain.

Each matched filter bank contains N different matched filters, one for each waveform, but the N matched filter banks are identical in every digital back-end 50x. For that reason, the matched filters have only one subscript, corresponding to the waveform for which they are designed. However, the remaining digital processing components are unique within each channel in each digital back-end 50x. These components have two subscripts, corresponding to the i^{th} receive path components that process the i^{th} transmitted waveform. These components compensate for the coherence parameters associated with each bistatic pair formed. The propagation delay induced by traversing a bistatic range Rᵢⱼ is compensated by [symbol] . The LO phase attachment contingent on transmission and reception times (and LO alignment) is compensated by [symbol] . Not shown is a frequency compensation that accounts for target Doppler and LO offsets in non-ideal circumstances which would be compensated by [symbol] . The hat above the variables indicates that these coherence parameter compensations are generally estimates of the actual value.

After the copies of the received signal are processed by the associated matched filter and coherence parameter correction, the results are summed. In turn, the output of each receiver 10 is then summed in a central processor 50. This is only a canonical system, and a person of skill in the art may choose to apply receiver specific coherence parameters, followed by another system wide set of coherence parameters prior to final summation.

In COR mode, coherence parameters, ( [symbol] ) are generally estimated from the data itself. This is made possible by the separable transmit waveforms allowing for unique measurements of the bistatic pair behavior. The exact estimation technique is irrelevant here, beyond the notion that it is performed after the data is received.

Signal Model: With the COR system as described above, the signal model can be defined with respect to the expected output of the system, A(t) as shown in Equation (2). Starting from left to right, the two summations are seen over the i=1 . . . N receivers followed by the summation across ji=1 . . . N paths in the matched filter for the associated transmit waveform. Inside the summation the received signals, Aᵢ are matched filtered via convolution against the time-reverse complex conjugate of the selected transmit waveform, sⱼ(−t)*.

A(t)=Σᵢ₌₁^{N}Σⱼ₌₁^{N}sⱼ(−t)**Aᵢ(t) (2)

The received signals Aᵢ(t) are defined by Equation (3). This is the superposition of all transmitted signals as they impinge on the receiving antenna 17 with the associated bistatic propagation delay, τᵢⱼ, phase difference, ϕᵢⱼ, and frequency offset, fᵢⱼ applied prior to summation. Moreover, a receiver specific noise term, nᵢ(t) is added to represent system noise.

Aᵢ(t)=[Σⱼ₌₁^{N}sⱼ(t−τᵢⱼ)e^{j2πf}^{ᵢⱼ}^{t+jϕ}^{ᵢⱼ}]+nᵢ(t) (3)

The triple summation is a result of the matched filter bank, due to Equation (1), and the matched filtering process in Equation (2) will only yield a single bistatic pair's response plus noise in the ideal case. This form of the equation, however, is more useful in the general case where ideal separability is unachievable and thus leakage terms degrade performance from the ideal case.

Another signal model would include the propagation loss due to bistatic range, Rᵢⱼ, as well as the target response subject to the bistatic angle, σ_{res,ij}. Propagation loss results in a variation in amplitude across the return, which proportionally scales the ideal case peak output. Target response also imposes variation in amplitude, much like propagation loss, but also imposes a phase shift which can be encapsulated in other phase error terms.

Cohere-On-Transmit

COT DCR systems may be implemented in using monostatic or bistatic radars in the same manner as COR systems. FIG. 6 illustrates a generalized COT architecture arranged as a bistatic radar analogous to the COR architecture shown in FIG. 5.

Transmit Side: In contrast to COR, in COT mode each of the N transmitters use the same waveform s(t). Under ideal conditions for COT, where all systems are perfectly synchronized, the transmit waveform can be chosen to optimize traditional radar performance (e.g., low range sidelobes, Doppler tolerance, etc.). However, for COT DCR the coherence parameter error tolerance must be considered in both system design and in waveform selection. For example, some COT performance analysis occurs using the sinc-like responses from idealized linearly frequency modulated (LFM) waveforms. In other analysis, used stepped frequency modulation (SFM) waveforms may be used in order to achieve greater delay-error (i.e., Et) tolerance, where the delay-error tolerance feature of the SFM waveform is directly correlated with the sub-pulse length (i.e., longer sub-pulses enhance tolerance). Therefore, a system design can manipulate the sub-pulse length to compensate for other systematic errors (such as position uncertainty). Waveform selection may also be influenced by overall system design considerations such as the ability to perform COR processing on the receive side with or without accurate position information of each receiver 10.

On the left side of FIG. 6 three of the N transmit paths are shown, the 1^{st}, j^{th} and N^{th}. The remaining transmit paths are omitted for clarity. In this diagram, all transmit paths comprise the same waveform, s(t)=s₁(t)= . . . =s_{N}(t), an RF transmitter 14, and a transmit antenna 15. The vertical ellipsis symbols represent the unseen paths. In each transmit path, the transmitter 14 applies the appropriate coherence parameters for each channel (not shown) and mixes the resulting baseband radar waveform with a common local oscillator (LO) shared by all transmit paths, up-converting it to an RF carrier frequency appropriate for radiation by the antenna 15. This is again largely similar to COR modalities with the exception of the application of coherence parameters on transmit and the identical waveforms.

In practice, an arbitrary waveform generator is likely going to apply transmit side coherence parameters during signal generation as in Equation (4), where Δₜ^{t}, Δ_{ϕ}^{t}, Δ_{f}^{t} are the transmit side coherence parameters for delay, phase, amplitude, and frequency. The use of Δ implies that the actual coherence parameter is not necessarily the same as the measured or estimated value. For example, the delay coherence parameter is not necessarily the measured bistatic delay. The super script t indicates this is the transmit side coherence parameter.

sₙ(t)=s(t−Δₜ^{t})e^{-jΔ}^{_{ϕ}}^{^{t}}e^{-j2πΔ}^{_{f}}^{^{t}}^{t} (4)

Freespace Propagation: The transmit paths for a COT system are synchronized in time so all N waveforms are transmitted by their antennas 15 such that they arrive at the target 16 at exactly the same time. In the ideal case, this ensemble is fully coherent such that a perfect summation of energy from all waveforms impinges on the target 16. This can be compared with COR modes, which may choose to transmit such that the waveforms leave the transmitters at exactly the same time. COR adaptive processing on the receive side calculates relative coherence parameters (CPs) between transmitters 14 directly from the data.

However, in COT modes the waves must constructively interact at the target 16 to achieve the proper superposition required for full coherent gain. After the transmitted waves are scattered by the target 16, a portion of their energy propagates to each of the N receive antennas 17. Consequently, COT performance cannot be recovered through signal processing as COR can. As a result, understanding the impact of the CPs on COT performance is critical.

Receive Side: In each receive path, the N received signals are down-converted by the receivers 16, and digitized for post-processing. In COT, as each transmitter 14 uses the same waveform each digital back-end 50y contains only a single processing channel. The processing channel, in this ideal case, comprises a matched filter, s*(−t), a delay adjustment, \hat{τ}, and a phase adjustment, \hat{ϕ}. The implementation of each back-end 50y is identical for all receivers 16. The parameters applied for delay and phase adjustment are unique to each receiver-only, versus a receiver-transmitter pair as in COR, therefore the associated sub-script is only a single index (e.g. the i^{th} receiver uses a delay and phase adjustment of [symbol] and \hat{ϕ}ᵢ respectively). The hat, as in \hat{τ}, denotes that the associated parameters are estimates and not necessarily the actual values, in the ideal case [symbol] =τᵢ.

Here, one may note that even in COT mode, COR compensations must be applied to achieve a fully coherent system. The key distinction from COR mode is that COT mode must estimate coherence parameters on transmit prior to transmission, in many cases this may also imply the ability to estimate the receive side coherence parameters a priori as well. In either case, the time constraints on a priori calculation is quite demanding, it must be calculated on the order of the pulse repetition interval (PRI) such that it is ready before the next pulse must be transmitted.

Signal Model: Next, the signal model is defined with respect to the expected output of the system, A(t) as shown in Equation (5). From left to right, the summation is shown over all receive channels. Each receive channel is the result of matched filtering with transmitted waveform, convolution by the time-reversed complex conjugate s(−t)*, against noise (isolation to emphasize a single noise signal per receiver 10) and the superposition of the transmitted signals with the associated bistatic propagation delay, τᵢⱼ, target Doppler and LO frequency offsets, fᵢⱼ, and transmit-to-receiver phase difference, ϕᵢⱼ.

$$A ( t ) = {\sum }_{i = 1}^{N} {s ( - t )}^{*} * {A}_{i} ( t ) \qquad ( 5 )$$

$$where ,$$

$${A}_{i} ( t ) = [ [ {\sum }_{j = 1}^{N} s ( t - {τ}_{ij} ) {e}^{j 2 π {f}_{ij} t + j {ϕ}_{ij}} ] + {n}_{i} ( t ) ]$$

Coherence Parameters and Error Tolerance

Coherence parameter (CP) error drives the fundamental bound on overall DCR performance. The CPs must be estimated with low error on exceptionally short timescales—on the order of a pulse repetition interval. The conventional solutions do not provide a complete analysis of all deterministic CP errors especially as a function of the number of radars in the DCR network. Consequently, the embodiments herein provide this missing and essential comprehensive technique. This advancement provided by the embodiments herein serves two purposes. First, it ameliorates a knowledge gap in requirements analysis for DCR, providing new understanding to system designers. Specifically, the error tolerance for each error source is shown to be a nonlinear function of network size. Second it will motivate the development of the mixed mode DCR (MM-DCR) framework further described below.

Next the one-way coherence loss due to errors in coherence parameters delay, phase, amplitude, and frequency from multiple transmitters to a single receiver is analyzed with respect to the number of radars in the system for the linear frequency modulated (LFM) waveform. To provide clarity to the analysis, the COR processing/synchronization is assumed to be perfect. This assumption is made for two reasons. First, the performance bounds caused by coherence parameter (CP) errors in COR are known. Therefore, the embodiments herein provide a new technique of the COT bounds to complete the CP requirements analysis of DCR. This analysis provides the motivation for the mixed-mode DCR concept further described below. Second, the impact of COR error may be easily folded into this analysis. In practice, actual losses will be worse than shown here under non-ideal COR performance.

In general, the peak of the output of a matched filter against the received signal is of most concern, as would be used in a radar case, rather than the peak amplitude of the time-domain sum. Thus, the simplified signal model (matched filtered response of the one-way propagation) is given by Equation (6). Where appropriate, the process normalizes by the energy of the matched filter waveform.

$${A}_{i} ( t ) = \frac{{s ( - t )}^{*}}{{\int }_{- ∞}^{∞} {\vert s ( t ) \vert}^{2}} * [ {\sum }_{j = 1}^{N} s ( t - {τ}_{j} ) {e}^{j 2 π {f}_{j} t + j {ϕ}_{j}} ] \qquad ( 6 )$$

For each delay, phase, and frequency offset term (τᵢⱼ, ϕᵢⱼ, fᵢⱼ respectively), the ideal coherence parameter (Δ_{τ}_{ᵢⱼ}, Δ_{ϕ}_{ᵢⱼ}, Δ_{f}_{ᵢⱼ}) and the estimated coherence parameter ( [symbol] ), have some residual error (∈_{τ}_{ᵢⱼ}, ∈_{ϕ}_{ᵢⱼ}, and ∈_{f}_{ᵢⱼ}) as given by Equation (7).

∈_{τ}_{ᵢⱼ}=Δ_{τ}_{ᵢⱼ}−

[symbol]

∈_{ϕ}_{ᵢⱼ}=Δ_{ϕ}_{ᵢⱼ}−

[symbol]

∈_{f}_{ᵢⱼ}=Δ_{f}_{ᵢⱼ}− [symbol] (7)

The following sections analyze the magnitude of the peak of the matched filtered response, for the case of constant progressive errors (i.e., the first radar may have no errors, the second E, the third 2E, and so on). All errors are assumed to be statistically independent. Table I shows the common parameters used for the analysis, which all assume an LFM transmit waveform. While the exact numerical analysis is of course waveform dependent, the trends shown hold in the general case.

TABLE 1
Common Simulation Parameters

| Parameter | Value | Units |
|---|---|---|
| Pulse Duration | 1 × 10⁻³ | Seconds |
| Instantaneous Bandwidth | 10,000 | Hz |

Phase Error

Rewriting Equation (6) to remove time and frequency offsets yields Equation (8).

$${A}_{i} ( t ) = \frac{{s ( - t )}^{*}}{{\int }_{- ∞}^{∞} {\vert s ( t ) \vert}^{2}} * [ {\sum }_{j = 1}^{N} s ( t ) {e}^{j {ϕ}_{j}} ] \qquad ( 8 )$$

It can be shown that for the peak of the matched filters main-lobe response this simplifies to the sum of the residual phases as in Equation (9) (ignoring amplitude differences).

A(0)=Σⱼ₌₁^{N}e^{jϕ}^{ⱼ} (9)

Applying Equation (7) to Equation (9) and taking the magnitude of the output yields Equation (10).

A(0)=|Σⱼ₌₁^{N}e^{j∈}^{_{ϕj}}| (10)

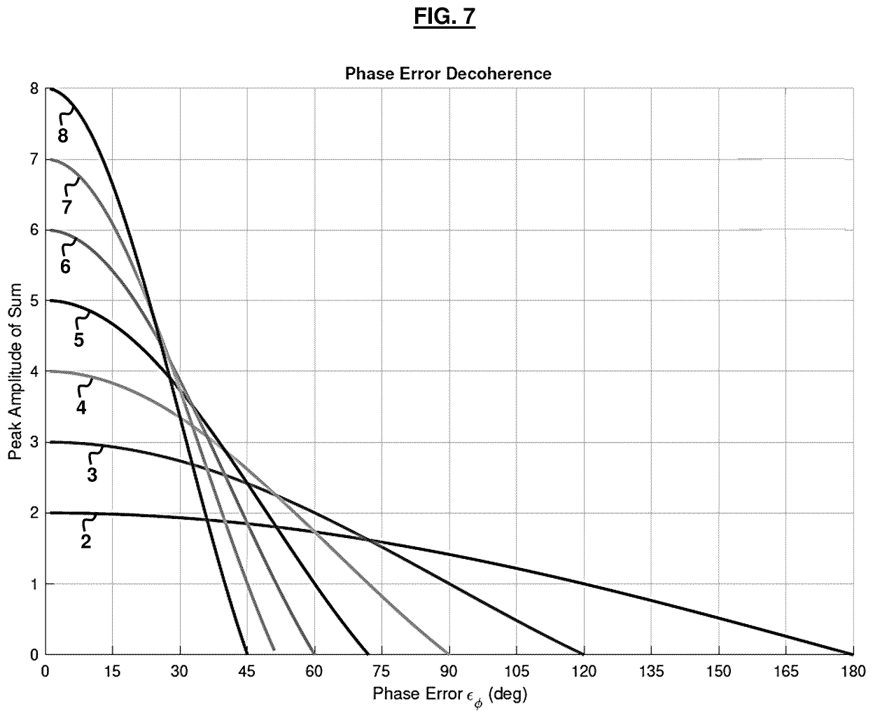

FIG. 7 shows the resulting system output for varying number of radars, N={2 . . . 8}, where each phase step is applied to the transmitting radar in a linear progression (i.e., ∈_{ϕj}=(j−1)ϕ). The peak amplitude of the sum is normalized to unity for each radar in the network. Therefore, the peak amplitude for N=8 with no phase errors is 4× as large as that of the case of N=2 radar nodes. As the number of elements increases the sensitivity to error increases in a nonlinear fashion. Consequently, DCR systems composed of a larger number of radar nodes may perform worse than systems with fewer radar nodes when the phase error becomes sufficiently large. For example, at 45° the N=8 case is fully deconstructive, with minimal observed energy from a target 16. In contrast, while the N=2 case has one quarter of the signal strength in the ideal case, it still has most of its signal preserved in the receiver 10.

Delay Error

Rewriting Equation (6) to remove phase and frequency offsets yields Equation (11).

$$A ( t ) = \frac{{s ( - t )}^{*}}{{\int }_{- ∞}^{∞} {\vert s ( t ) \vert}^{2}} * [ {\sum }_{j = 1}^{N} s ( t - {τ}_{j} ) ] \qquad ( 11 )$$

The objective to achieve coherence is to find some common delay offset r such that Equation (12) holds true.

τ=τᵢⱼ−Δ_{t,ij}∀i,j (12)

To simplify the equations, without loss of generality assume that τ=0. As a result, combining Equation (11) with Equation (7) yields Equation (13).

$$A ( t ) = \frac{{s ( - t )}^{*}}{{\int }_{- ∞}^{∞} {\vert s ( t ) \vert}^{2}} * [ {\sum }_{j = 1}^{N} s ( t - {ϵ}_{{τ}_{j}} ) ] \qquad ( 13 )$$

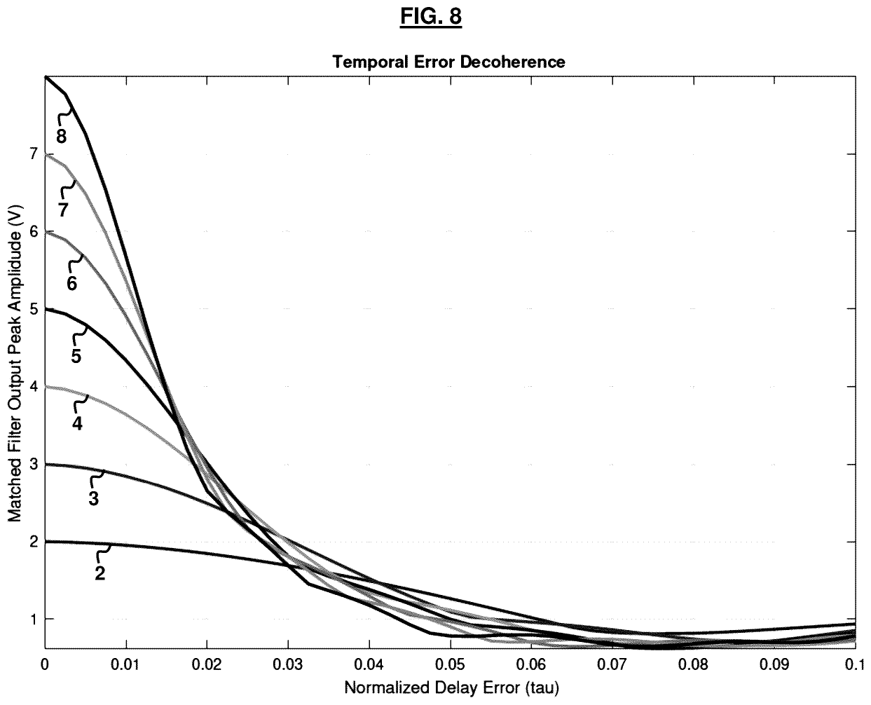

This indicates the delay error decoherence is waveform dependent. As previously mentioned, an LFM is used for this analysis. FIG. 8 shows the delay error induced decoherence for varying numbers of radars in a system N={2, 3, . . . , 8} over delays from zero to a fraction of the pulse length (normalized by the pulse length).

Again, it is observed that as the number of elements increases, the system exhibits increased sensitivity to delay coherence parameter error, and again, systems with fewer elements may produce better results for a given error.

Frequency Error

Rewriting Equation (6) to remove phase and delay offsets yields Equation (14).

$$A ( t ) = \frac{{s ( - t )}^{*}}{{\int }_{- ∞}^{∞} {\vert s ( t ) \vert}^{2}} * [ {\sum }_{j = 1}^{N} s ( t ) {e}^{j 2 π {f}_{j} t} ] \qquad ( 14 )$$

Assuming the frequency coherence parameter ideally yields no frequency offset, Equation (7) is combined with Equation (14) to yield Equation (15).

$$A ( t ) = \frac{{s ( - t )}^{*}}{{\int }_{- ∞}^{∞} {\vert s ( t ) \vert}^{2}} * [ {\sum }_{j = 1}^{N} s ( t ) {e}^{j 2 π ϵ {f}_{j} t} ] \qquad ( 15 )$$

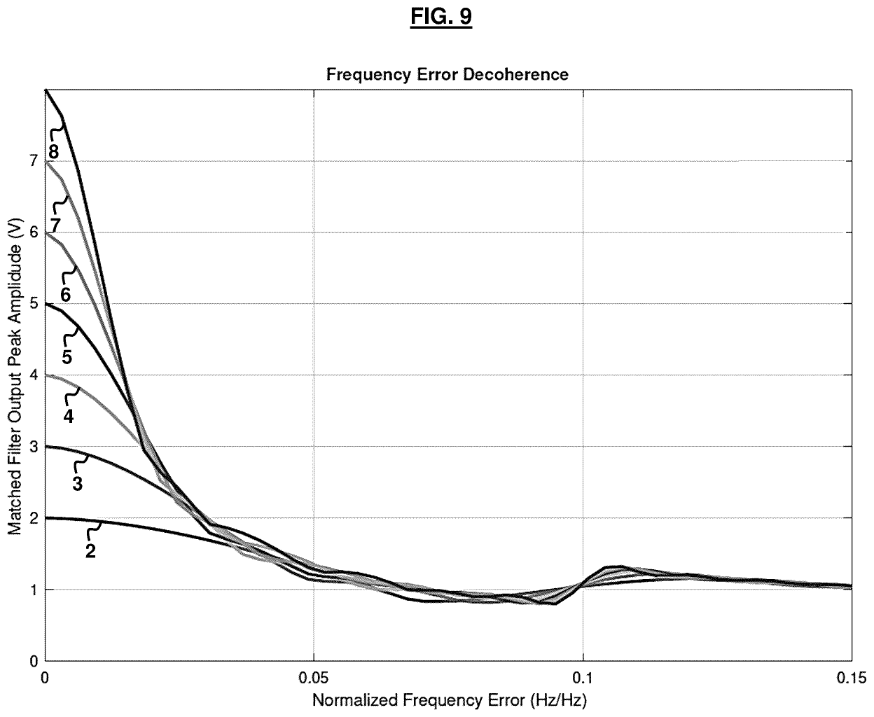

FIG. 9 shows the frequency error induced decoherence for varying numbers of radars in a system N={2, 3, . . . , 8}.

It is observed that as the number of elements in the system increases the sensitivity to frequency coherence parameter error increases. However, in contrast with other coherence parameters using fewer radars has a negligible ability to improve performance overall.

Mixed Mode DCR

With no CP errors COT mode offers a peak N³ SNR gain, while COR mode offers a maximum of N² SNR gain. Consequently, switching between the modes leads to a loss factor of N which can be quite large as the system size increases. First, COR CPs must be processed from the data, but given advanced processing they may theoretically have any latency (that the system designer is willing to tolerate). Second, COT CPs must be processed prior to transmission and thus the latency must be less than the PRI of the radar system. These two points imply a relaxation of computational requirements when switching from COT to COR, whereas COT has much more stringent requirements for CPs. Specifically, it is shown above that coherence loss due to CP error, ∈_{ϕ}, ∈_{τ}, and ∈_{f}, is more sensitive as the number of elements in a DCR system is increased. In particular, this sensitivity has a non-linear relationship with the number of systems N.

Therefore, for large values of N individual nodes, COT DCR systems must maintain rigid CP requirements. When CPs fall out of tolerance, the DCR must drop back into COR and instantaneously drop the peak achievable SNR by a factor of N. Further, to the two points listed above, there is also a need to relax the compute latency demand and improve the CP error tolerance.

As a result, the embodiments herein provide a mixed-mode DCR (MM DCR) technique. Sub-arrays are often used in traditional phased arrays to mitigate complexity in system design. Similarly, the embodiments herein consider the use of distributed subarrays. Each sub-array operates in a COT mode, utilizing (pseudo) orthogonal waveforms. Therefore, each of the COT sub-arrays can then be combined in an overall COR mode. The sub-array size is therefore the “knob” that can be adjusted to optimize performance for a given estimate of CP errors. As the errors increase the sub-array size can decrease and the overall distributed radar performance gracefully transitions from the peak gain of N³ down to the limit of COR gain of N² for a sub-array size of 1. Further, the computational costs to achieve COR are reduced as COR depend on the number of sub-arrays.

Equation (16) provides the total mixed-mode performance, G_{Total}, which is a product of the COR performance across sub-arrays, G_{COR}, with the COT performance of a single sub-array, G_{COT}. The simplified forms are provided, with the final version allowing trivial comparison to COR and COT traditional performance notation N² and N³ respectively.

$$\begin{matrix}{G}_{Total} = {G}_{COR} {G}_{COT} \\ = {( \frac{N}{M} )}^{2} {M}^{3} \\ = {N}^{2} M \\ = {N}^{2 + {log}_{N} ( M )} \\ {G}_{Total} = {N}^{( 2 + \frac{{log}_{10} ( M )}{{log}_{10} ( N )} )}\end{matrix} \qquad ( 16 )$$

For example, consider a DCR of N=8 radars, which is decomposed into two sub-arrays of M=4 radars per subarray. The sub-apertures operate with a common waveform in a COT mode achieving an N³ SNR gain of G_{COT}=64(18 dB). Next, as each sub-array is transmitting a waveform (approximately) orthogonal to the other sub-arrays, the N/M=2 sub-arrays can be combined using COR techniques resulting in an N² SNR gain of G_{COR}=4(6 dB). Combining the COR and COT performance yields an overall SNR gain of G_{Total}=256(24 dB), equivalent to N^{2.67}. Recall that the overall DCR gain is bound between N² for COR and N³ for COT, so the peak gain in this scenario would be N³=512(27 dB). Thus, 6 dB of gain is achieved over COR with only 3 dB of loss from COT. However, these are peak gains. The MM DCR system suffers from 3 dB of loss from COT while improving system error tolerances. Therefore, the MM DCR may realize a greater gain than the traditional COT in operation under certain error conditions.

Equation (16) provides two additional forms which facilitate comparison to canonical COR and COT performance bounds. The first form requires the ability to compute arbitrarily based logarithms, while the equivalent second form is more readily computable with base 10 logarithms. It is observed that as M→1 the performance limit is equivalent to COR mode, and as M→N it is bounded by COT performance.

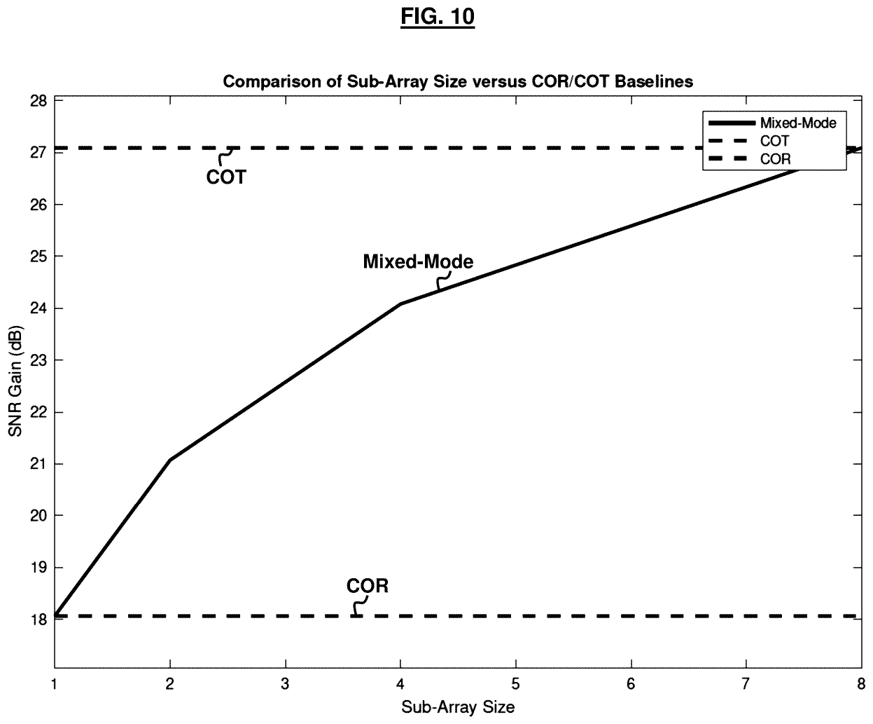

FIG. 10 shows an example DCR system composed of 8 radars. The dashed COT line is the maximum achievable performance, limited by fully COT mode. The dashed COR line is the minimum performance, defined by fully COR mode. The solid line shows the mixed mode SNR gain.

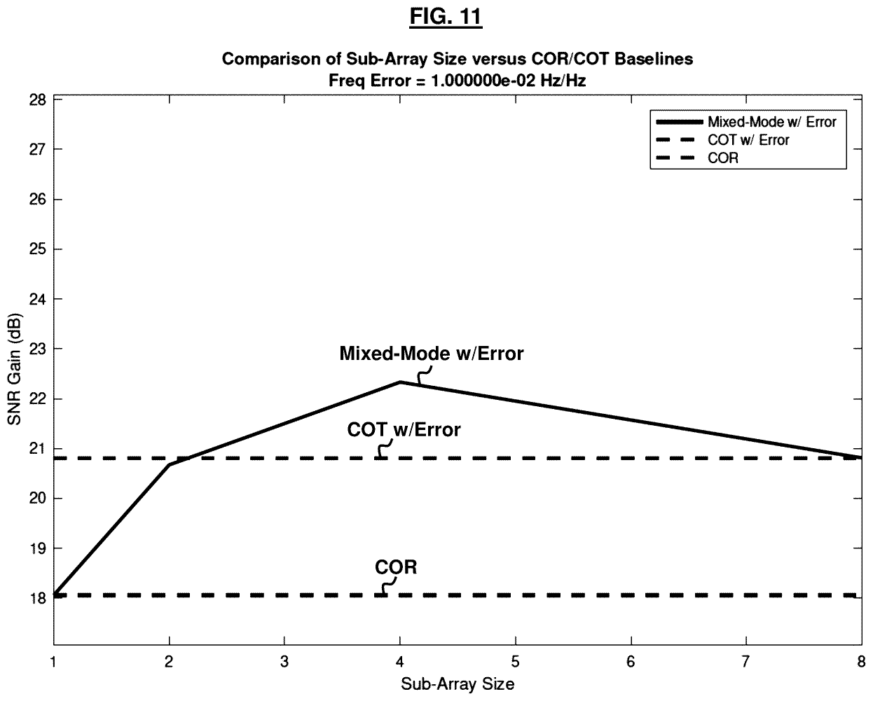

FIG. 11 shows the improved robustness to error provided by MM DCR for a single simple test case for illustration. A frequency error is applied as in FIG. 9, the loss is doubled to account for 2-way propagation (this assumption may vary from practice which may have geometry dependent losses that are not reciprocal, especially in DCR systems composed of bistatic radars). The loss is then subtracted from each subarray as well as the COT baseline performance. It is shown that at this error level applied to COT sub-arrays, MM DCR achieves greater gain than operating in a fully COT mode. This behavior is not limited to frequency CP errors, and trivially extends to the other CPs.

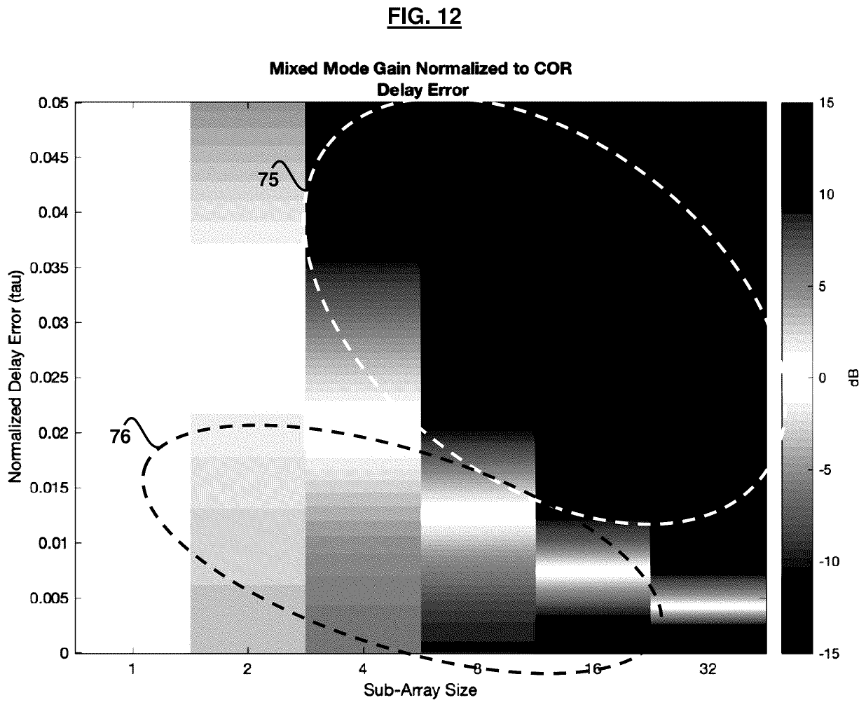

FIGS. 12-14 show the performance of MMDCR normalized to COR mode for varying sub-array size and CP error for all three coherence parameters (delay, phase, and frequency respectively). For this simulation an array of size 32 was used to demonstrate the scalability of the error analysis and MM-DCR mode. A chirp waveform as described in Table I is used for the analysis. These results are waveform dependent. These simulations assume that COR performance is ideal (e.g., cross-channel leakage is negligible between channels, CPs can be estimated perfectly). This assumption is not particularly far-fetched, for example, with brute force techniques CPs can be estimated very accurately.

The left most column of FIGS. 12-14 is COR mode operation and thus provides the performance baseline. Consequently, the MM-DCR performance is normalized to the COR gain. Similarly, the right most column of FIGS. 12-14 is COT mode operation using the full network of radars. The general areas 75 on the plot show performance loss versus COR mode and the general areas 76 show performance gain. After errors grow sufficiently large, there is never any performance benefit to moving out of COR mode. Below this critical error level, MM-DCR performance shows improved performance over COR mode. For a given error, if the COT mode performance is in general area 75 (a loss compared to COR) and a MM-DCR value is in general area 76 (a gain compared to COR) the use of MM-DCR is viable and offers a graceful performance degradation over dropping from COT to COR mode directly.

These results show that for the system of 32 constituent radars, MM-DCR offers improved performance compared with COR mode over significant regions. Ignoring the error free case MM-DCR improves performance over COR:
up to approximately 0.03τ delay error (∈_{τ}),
up to approximately 60° of phase error (∈_{ϕ}), and
up to approximately 0.03 Hz/Hz frequency error (∈_{f}).

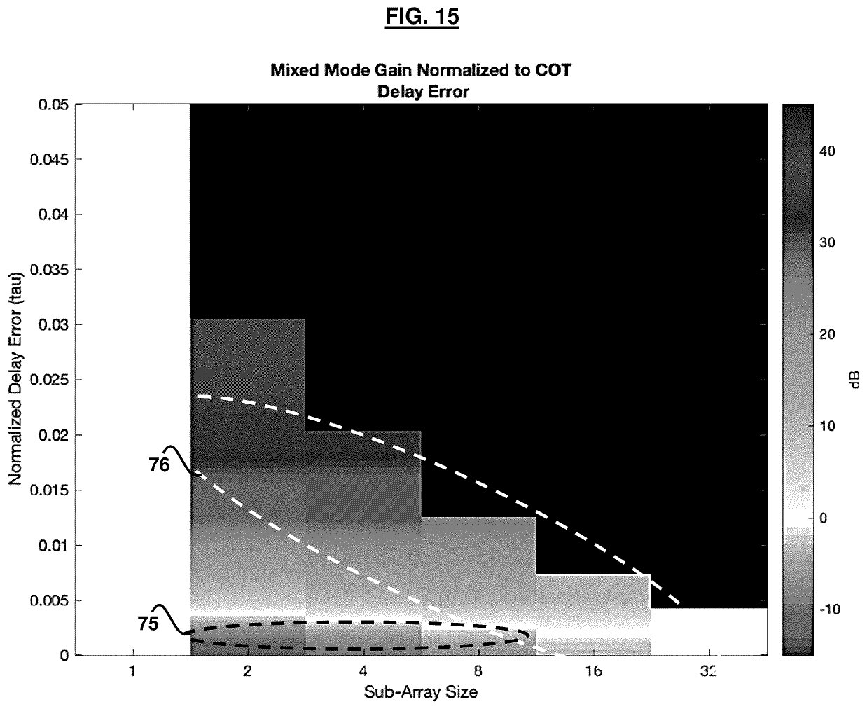

FIGS. 15-17 show the performance improvement of MM-DCR normalized to COT mode for varying sub-array size and CP error for all three coherence parameters (delay, phase, and frequency respectively). Additionally, in this case, only the regions with performance above COR mode are shown. Areas with worse performance than COR mode (as shown in the previous figures), are blacked out and would never be used in practice. Again, general areas 75 show decreased performance and general areas 76 show increased performance (with respect to COT). Therefore, general areas 75 of performance should be avoided to maximize performance, and the remaining general areas 76 highlight the space where MM-DCR provides performance improvement.

For each sub-array size (column) the loss for COT performance was calculated over the error range. This COT loss was doubled to account for two way losses. The gain scale is capped such that infinite gains over COT (in cases where perfectly destructive interference would occur in COT mode) do not saturate the scale. Varying the number of radars in the system will change the results of this analysis.

It is clear, that MM-DCR provides improved performance over COT and COR over a large region of errors as given in Equation (17).

0.0025τ≲∈_{τ}≲0.03τ (seconds)

5°≲∈_{ϕ}≲60° (degrees)

0.0025≲∈_{f}≲0.03 (Hz/Hz) (17)

Beyond graceful performance degradation and increased coherence parameter error tolerance MM DCR opens the door to many potential applications. For example, if the system is designed such that the number of radars in the system is greater than the number required to achieve a specified performance goal, a continuous coherence calibration is possible. A principal array can be formed using only the radars necessary to achieve performance. The remaining radars can operate in a COR mode, and coherence parameters may be estimated and confirmed if the contribution increases SNR. In this manner, the system can iterate through each radar in the system, moving it from the principal array to a calibration array, estimating its coherence parameters, then returning it to the principal array. As a second example, the selection of elements in each sub-array can be permuted to vary the array pattern and suppress side-lobes of each sub-array. In this regime, grating-lobe effects which may deleteriously affect coherence parameter estimation may be suppressed.

The embodiments herein provide for the sensitivity analysis and a technique of COR and COT DCR modes to deterministic CP error that extends previous analyses by varying the number of elements in the system and evaluating all CP errors. The results show nonlinear dependence between array size and CP error. This nonlinear behavior causes catastrophic loss of DCR performance when the CP error grows too large. This sensitivity analysis has motivated the development of the MM DCR technique provided by the embodiments herein. By balancing CP errors and sub-array sizes the DCR may adaptively achieve peak performance, rather than being faced with a binary choice of COT or COR. Further, in some cases the use of sub-arrays may exceed even full COT performance in practice due to the reduction in sensitivity to CP errors.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Those skilled in the art will recognize that the embodiments herein can be practiced with modification within the spirit and scope of the appended claims.

What is claimed is:

1. A method comprising:
receiving, by a plurality of receivers, a combination of separable transmit waveforms from a plurality of transmitters, wherein the plurality of transmitters are grouped into a sub-array;
processing, by each receiver of the plurality of receivers, the combination of separable transmit waveforms to estimate coherence parameters associated with each separable transmit waveform of the combination of separable transmit waveforms;
based on an estimation of the coherence parameters, determining, by each receiver of the plurality of receivers, a signal model of a next set of transmissions of the separable transmit waveforms transmitted by the plurality of transmitters;
processing the signal model according to a mixed-mode distributed coherent radar operating mode that is a function of coherence parameter errors associated with each separable transmit waveform and a size of the sub-array, wherein the coherence parameter errors comprise errors of the plurality of transmitters and the plurality of receivers, and wherein the signal model comprises a coherence parameter tolerance of a radar system comprising the plurality of transmitters and the plurality of receivers; and
sending the processed signal model to the plurality of transmitters for each transmitter of the plurality of transmitters to generate its own separable transmit waveform selected from the separable waveforms for transmission.

2. The method of claim 1, further comprising transmitting a separable transmit waveform from each of the plurality of transmitters, wherein each transmitter of the plurality of transmitters transmits its own separable transmit waveform independent of separable transmit waveforms transmitted from other transmitters of the plurality of transmitters.

3. The method of claim 1, wherein the coherence parameter tolerance is dependent on the size of the sub-array.

4. The method of claim 1, wherein the processed signal model instructs the radar system to operate in the mixed-mode distributed coherent radar operating mode, a cohere-on-transmit (COT) operating mode, or a cohere-on-receive (COR) operating mode.

5. The method of claim 1, wherein the processed signal model provides operating instructions to the radar system on how to collectively improve system performance of the radar system given a current state of the coherence parameter errors.

6. The method of claim 5, wherein the operating instructions comprise selectively choosing different combinations of the separable transmit waveforms for transmission by each transmitter.

7. The method of claim 1, wherein determining the signal model comprises performing an analysis of the number of radars in the radar system vs. a coherence parameter error tolerance of the radar system.

8. A machine-readable storage medium comprising computer-executable instructions that when executed cause a processor to:
identify a combination of separable transmit waveforms received by a plurality of receivers from a plurality of transmitters, wherein the plurality of transmitters are grouped into a sub-array;
instruct each receiver of the plurality of receivers to process the combination of separable transmit waveforms to estimate coherence parameters associated with each separable transmit waveform of the combination of separable transmit waveforms;
instruct each receiver of the plurality of receivers, based on an estimation of the coherence parameters, how to determine a signal model of a next set of transmissions of the separable transmit waveforms transmitted by the plurality of transmitters;
process the signal model according to a mixed-mode distributed coherent radar operating mode that is a function of coherence parameter errors associated with each separable transmit waveform and a size of the sub-array, wherein the coherence parameter errors comprise errors of the plurality of transmitters and the plurality of receivers, and wherein the signal model comprises a coherence parameter tolerance of a radar system comprising the plurality of transmitters and the plurality of receivers; and
send the processed signal model to the plurality of transmitters for each transmitter of the plurality of transmitters to generate its own separable transmit waveform selected from the separable waveforms for transmission.

9. The machine-readable storage medium of claim 8, wherein the instructions, when executed, further cause the processor to instruct the plurality of transmitters to transmit a separable transmit waveform from each of the plurality of transmitters, wherein each transmitter of the plurality of transmitters is instructed to transmit its own separable transmit waveform independent of separable transmit waveforms transmitted from other transmitters of the plurality of transmitters.

10. The machine-readable storage medium of claim 8, wherein the coherence parameter tolerance is dependent on the size of the sub-array.

11. The machine-readable storage medium of claim 8, wherein the processed signal model instructs the radar system to operate in the mixed-mode distributed coherent radar operating mode, a cohere-on-transmit (COT) operating mode, or a cohere-on-receive (COR) operating mode.

12. The machine-readable storage medium of claim 8, wherein the processed signal model provides operating instructions to the radar system on how to collectively improve system performance of the radar system given a current state of the coherence parameter errors.

13. The machine-readable storage medium of claim 12, wherein the operating instructions comprise selectively choosing different combinations of the separable transmit waveforms for transmission by each transmitter.

14. The machine-readable storage medium of claim 8, wherein determining the signal model comprises performing an analysis of the number of radars in the radar system vs. a coherence parameter error tolerance of the radar system.

15. A system comprising:
a plurality of transmitters, wherein the plurality of transmitters are to transmit a separable transmit waveform from each of the plurality of transmitters, wherein each transmitter of the plurality of transmitters transmits its own separable transmit waveform independent of separable transmit waveforms transmitted from other transmitters of the plurality of transmitters, and wherein the plurality of transmitters are grouped into a sub-array;
a plurality of receivers, wherein each of the plurality of receivers are to receive a combination of separable transmit waveforms from the plurality of transmitters, wherein based on an estimation of the coherence parameters, each receiver is to determine a signal model of a next set of transmissions of the separable transmit waveforms transmitted by the plurality of transmitters; and
a processor to:
process the signal model according to a mixed-mode distributed coherent communication sub-system operating mode that is a function of coherence parameter errors associated with each separable transmit waveform and a size of the sub-array, wherein the coherence parameter errors comprise errors of the plurality of transmitters and the plurality of receivers, and wherein the signal model comprises a coherence parameter tolerance of a communication sub-system comprising the plurality of transmitters and the plurality of receivers; and
send the processed signal model to the plurality of transmitters for each transmitter of the plurality of transmitters to generate its own separable transmit waveform selected from the separable waveforms for transmission.

16. The system of claim 15, wherein the coherence parameter tolerance is dependent on the size of the sub-array.

17. The system of claim 15, wherein the processed signal model instructs the communication sub-system to operate in the mixed-mode distributed coherent transceiver system operating mode, a cohere-on-transmit (COT) operating mode, or a cohere-on-receive (COR) operating mode.

18. The system of claim 15, wherein the processed signal model provides operating instructions to the communication sub-system on how to collectively improve system performance of the communication sub-system given a current state of the coherence parameter errors.

19. The system of claim 18, wherein the operating instructions comprise selectively choosing different combinations of the separable transmit waveforms for transmission by each transmitter.

20. The system of claim 15, wherein each receiver is to determine the signal model by performing an analysis of the number of components in the communication sub-system vs. a coherence parameter error tolerance of the communication sub-system.
